(19) United States
(12) Patent Application Publication
(10) Pub. No.: US 2018/0032335 A1
(43) Pub. Date: Feb. 1, 2018

(54) TRANSACTIONAL REGISTER FILE FOR A PROCESSOR

(71) Applicant: Microsoft Technology Licensing, LLC, Redmond, WA (US)

(72) Inventors: Aaron L. Smith, Seattle, WA (US); Jan S. Gray, Bellevue, WA (US)

(73) Assignee: Microsoft Technology Licensing, LLC, Redmond, WA (US)

(21) Appl. No.: 15/224,593

(22) Filed: Jul. 31, 2016

(51) Int. Cl. G06F 9/30

(52) U.S. Cl. CPC G06F 9/30043; G06F 9/3016; G06F 9/30101

(57) ABSTRACT

Technology related to register files for block-based processor architectures is disclosed. In one example of the disclosed technology, a processor core including a transactional register file and an execution unit can be used to execute an instruction block. The transactional register file can include a plurality of registers, where each register includes a previous value field and a next value field. The previous value field can be updated when a register-write message is received and the processor core is in a first state. The next value field can be updated when a register-write message is received and the processor core is in a second state. The execution unit can execute instructions of the instruction block. The execution unit can be configured to read register values from the previous value field and to cause register-write messages to be transmitted from the processor core when executing instructions that write to the registers.

### BACKGROUND

Microprocessors have benefitted from continuing gains in transistor count, integrated circuit cost, manufacturing capital, clock frequency, and energy efficiency due to continued transistor scaling predicted by Moore's law, with little change in associated processor Instruction Set Architectures (ISAs). However, the benefits realized from photolithographic scaling, which drove the semiconductor industry over the last 40 years, are slowing or even reversing. Reduced Instruction Set Computing (RISC) architectures have been the dominant paradigm in processor design for many years. Out-of-order superscalar implementations have not exhibited sustained improvement in area or performance. Accordingly, there is ample opportunity for improvements in processor ISAs to extend performance improvements.

### SUMMARY

Methods, systems, apparatus, and computer-readable storage devices are disclosed for a load-store queue of a block-based processor instruction set architecture (BB-ISA). The described techniques and tools can potentially improve processor performance and can be implemented separately, or in various combinations with each other. As will be described more fully below, the described techniques and tools can be implemented in a digital signal processor, microprocessor, application-specific integrated circuit (ASIC), a soft processor (e.g., a microprocessor core implemented in a field programmable gate array (FPGA) using reconfigurable logic), programmable logic, or other suitable logic circuitry. As will be readily apparent to one of ordinary skill in the art, the disclosed technology can be implemented in various computing platforms, including, but not limited to, servers, mainframes, cellphones, smartphones, PDAs, handheld devices, handheld computers, touch screen tablet devices, tablet computers, wearable computers, and laptop computers.

In some examples of the disclosed technology, a processor core can be used for executing an instruction block. The processor core can include a transactional register file and an execution unit. The transactional register file can include a plurality of registers, where each register includes a previous value field and a next value field. The previous value field can be updated when a register-write message is received and the processor core is executing speculatively so that the previous value field can store a value corresponding to a state before execution of the instruction block on the processor core. The next value field can be updated when a register-write message is received and the processor core is executing non-speculatively so that the next value field can store a value corresponding to a state after execution of the instruction block on the processor core. The execution unit can be configured to execute instructions of the instruction block. The execution unit can be configured to read register values from the previous value field of the transactional register file and to cause register-write messages to be transmitted from the processor core when the instructions of the instruction block write to the registers.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The foregoing and other objects, features, and advantages of the disclosed subject matter will become more apparent from the following detailed description, which proceeds with reference to the accompanying figures.

### BRIEF DESCRIPTION OF THE DRAWINGS

FIG. 1 illustrates a block-based processor including multiple processor cores, as can be used in some examples of the disclosed technology.

FIG. 2 illustrates a block-based processor core, as can be used in some examples of the disclosed technology.

FIG. 3 illustrates a number of instruction blocks, according to certain examples of disclosed technology.

FIG. 4 illustrates portions of source code and respective instruction blocks.

FIG. 5 illustrates block-based processor headers and instructions, as can be used in some examples of the disclosed technology.

FIG. 6 is a flowchart illustrating an example of a progression of states of a processor core of a block-based processor.

FIG. 7 illustrates an example snippet of instructions of a program for a block-based processor.

FIGS. 8-9 illustrate an example system including multiple processor cores and a transactional register file for executing instruction blocks of a program, as can be used in some examples of the disclosed technology.

FIG. 10 illustrates an example state diagram for a block-based processor core, as can be used in some examples of the disclosed technology.

FIGS. 11-12 are flowcharts illustrating example methods of executing instruction blocks of a program on a processor comprising multiple block-based processor cores, as can be performed in some examples of the disclosed technology.

FIG. 13 is a block diagram illustrating a suitable computing environment for implementing some embodiments of the disclosed technology.

### DETAILED DESCRIPTION

### I. General Considerations

This disclosure is set forth in the context of representative embodiments that are not intended to be limiting in any way.

As used in this application the singular forms “a,” “an,” and “the” include the plural forms unless the context clearly dictates otherwise. Additionally, the term “includes” means “comprises.” Further, the term “coupled” encompasses mechanical, electrical, magnetic, optical, as well as other practical ways of coupling or linking items together, and does not exclude the presence of intermediate elements between the coupled items. Furthermore, as used herein, the term “and/or” means any one item or combination of items in the phrase.

The systems, methods, and apparatus described herein should not be construed as being limiting in any way. Instead, this disclosure is directed toward all novel and non-obvious features and aspects of the various disclosed embodiments, alone and in various combinations and subcombinations with one another. The disclosed systems, methods, and apparatus are not limited to any specific aspect or feature or combinations thereof, nor do the disclosed things and methods require that any one or more specific advantages be present or problems be solved. Furthermore, any features or aspects of the disclosed embodiments can be used in various combinations and subcombinations with one another.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “produce,” “generate,” “display,” “receive,” “emit,” “verify,” “execute,” and “initiate” to describe the disclosed methods. These terms are high-level descriptions of the actual operations that are performed. The actual operations that correspond to these terms will vary depending on the particular implementation and are readily discernible by one of ordinary skill in the art.

Theories of operation, scientific principles, or other theoretical descriptions presented herein in reference to the apparatus or methods of this disclosure have been provided for the purposes of better understanding and are not intended to be limiting in scope. The apparatus and methods in the appended claims are not limited to those apparatus and methods that function in the manner described by such theories of operation.

Any of the disclosed methods can be implemented as computer-executable instructions stored on one or more computer-readable media (e.g., computer-readable media, such as one or more optical media discs, volatile memory components (such as DRAM or SRAM), or nonvolatile memory components (such as hard drives)) and executed on a computer (e.g., any commercially available computer, including smart phones or other mobile devices that include computing hardware). Any of the computer-executable instructions for implementing the disclosed techniques, as well as any data created and used during implementation of the disclosed embodiments, can be stored on one or more computer-readable media (e.g., computer-readable storage media). The computer-executable instructions can be part of, for example, a dedicated software application or a software application that is accessed or downloaded via a web browser or other software application (such as a remote computing application). Such software can be executed, for example, on a single local computer (e.g., with general-purpose and/or block-based processors executing on any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C, C++, Java, or any other suitable programming language. Likewise, the disclosed technology is not limited to any particular computer or type of hardware. Certain details of suitable computers and hardware are well-known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

### II. Introduction to the Disclosed Technologies

Superscalar out-of-order microarchitectures employ substantial circuit resources to rename registers, schedule instructions in dataflow order, clean up after miss-speculation, and retire results in-order for precise exceptions. This includes expensive energy-consuming circuits, such as deep, many-ported register files, many-ported content-accessible memories (CAMs) for dataflow instruction scheduling wakeup, and many-wide bus multiplexers and bypass networks, all of which are resource intensive. For example, FPGA-based implementations of multi-read, multi-write-port random-access memories (RAMs) typically require a mix of replication, multi-cycle operation, clock doubling, bank interleaving, live-value tables, and other expensive techniques.

The disclosed technologies can realize energy efficiency and/or performance enhancement through application of techniques including high instruction-level parallelism (ILP), out-of-order, superscalar execution, while avoiding substantial complexity and overhead in both processor hardware and associated software. In some examples of the disclosed technology, a block-based processor comprising multiple processor cores uses an Explicit Data Graph Execution (EDGE) ISA designed for area- and energy-efficient, high-ILP execution. In some examples, use of EDGE architectures and associated compilers finesses away much of the register renaming, CAMs, and complexity. In some examples, the respective cores of the block-based processor can store or cache fetched and decoded instructions that may be repeatedly executed, and the fetched and decoded instructions can be reused to potentially achieve reduced power and/or increased performance

In certain examples of the disclosed technology, an EDGE ISA can eliminate the need for one or more complex architectural features, including register renaming, dataflow analysis, misspeculation recovery, and in-order retirement while supporting mainstream programming languages such as C and C++. In certain examples of the disclosed technology, a block-based processor executes a plurality of two or more instructions as an atomic block. Block-based instructions can be used to express semantics of program data flow and/or instruction flow in a more explicit fashion, allowing for improved compiler and processor performance. In certain examples of the disclosed technology, an explicit data graph execution instruction set architecture (EDGE ISA) includes information about program control flow that can be used to improve detection of improper control flow instructions, thereby increasing performance, saving memory resources, and/or and saving energy.

In some examples of the disclosed technology, instructions organized within instruction blocks are fetched, executed, and committed atomically. Intermediate results produced by the instructions within an atomic instruction block are buffered locally until the instruction block is committed. When the instruction block is committed, updates to the visible architectural state resulting from executing the instructions of the instruction block are made visible to other instruction blocks. Instructions inside blocks execute in dataflow order, which reduces or eliminates using register renaming and provides power-efficient out-of-order execution. A compiler can be used to explicitly encode data dependencies through the ISA, reducing or eliminating burdening processor core control logic from rediscovering dependencies at runtime. Using predicated execution, intra-block branches can be converted to dataflow instructions, and dependencies, other than memory dependencies, can be limited to direct data dependencies. Disclosed target form encoding techniques allow instructions within a block to communicate their operands directly via operand buffers, reducing accesses to a power-hungry, multi-ported physical register files.

Between instruction blocks, instructions can communicate using visible architectural state such as memory and registers. Thus, by utilizing a hybrid dataflow execution model, EDGE architectures can still support imperative programming languages and sequential memory semantics, but desirably also enjoy the benefits of out-of-order execution with near in-order power efficiency and complexity. The different instruction blocks of a program can execute in parallel on multiple processor cores of a processor. For example, a non-speculative instruction block can execute on a first processor core and one or more speculative instruction blocks can execute on additional processor cores. The speculative instruction blocks may depend on architecturally visible results from the non-speculative instruction block and speculatively executed instruction blocks earlier in program order. In a basic approach to maintain the atomic nature of the instruction blocks, the results from earlier executed instruction blocks are not made available until the instruction blocks commit However, this approach may reduce the amount of work that can be performed in parallel as later executed instruction blocks may stall while waiting for earlier instruction blocks to commit

As disclosed herein, the processor cores of a processor can forward uncommitted state to processor cores speculatively executing instruction blocks later in the program flow. Specifically, a transactional register file can be used to maintain the atomic nature of the instruction blocks while forwarding speculative uncommitted state to instruction blocks executing later in program order. Additionally, the transactional register file can be used by a processor core to track when an earlier executing instruction block is a source of a register value that has not yet been generated, and instructions dependent on the to-be-generated register value can be delayed until the register value is generated. Compiler-generated state, such as a write mask for each instruction block, can be used by the transactional register file to aid with the tracking and potentially reduce hardware complexity. Additionally, the transactional register file can be used by the processor core to roll-back any uncommitted changes to register values when an instruction block is aborted due to mispeculation or an internal abort condition of the instruction block. By using the transactional register file, hardware complexity can potentially be reduced (compared to register renaming logic) and the performance can potentially be increased while maintaining an atomic transaction computational model. As will be readily understood to one of ordinary skill in the relevant art, a spectrum of implementations of the disclosed technology are possible with various area, performance, and power tradeoffs.

### III. Example Block-Based Processor

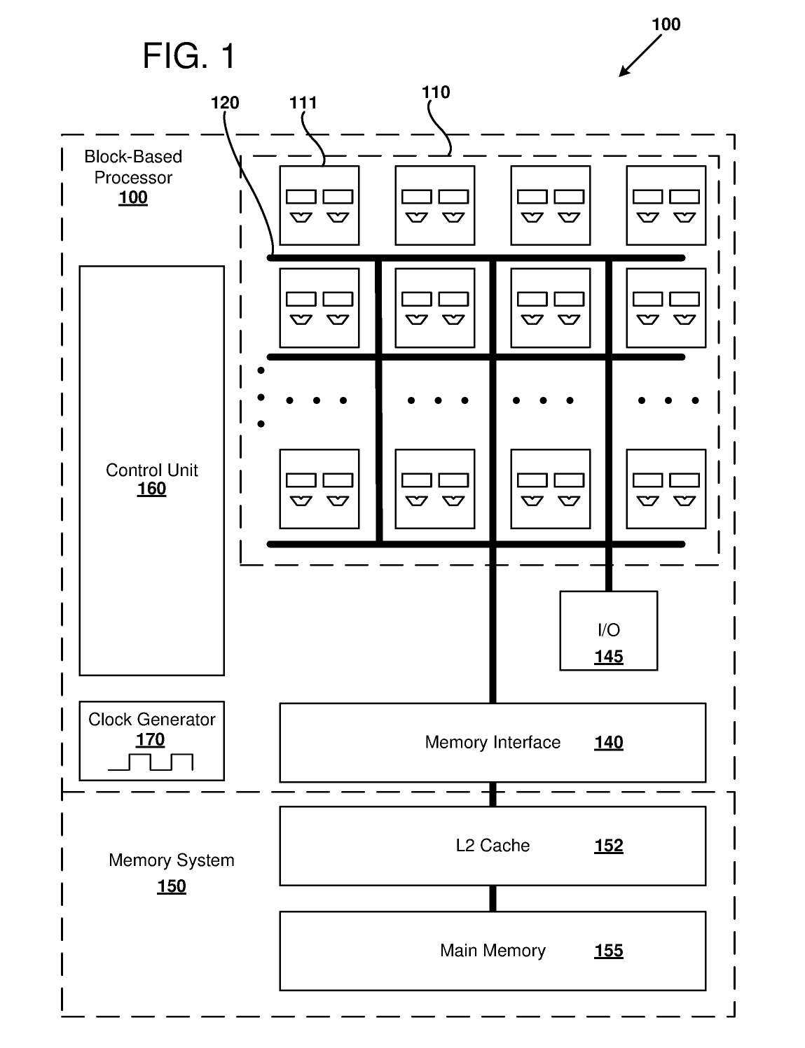

FIG. 1 is a block diagram 10 of a block-based processor 100 as can be implemented in some examples of the disclosed technology. The processor 100 is configured to execute atomic blocks of instructions according to an instruction set architecture (ISA), which describes a number of aspects of processor operation, including a register model, a number of defined operations performed by block-based instructions, a memory model, interrupts, and other architectural features. The block-based processor includes a plurality of processing cores 110, including a processor core 111.

As shown in FIG. 1, the processor cores are connected to each other via core interconnect 120. The core interconnect 120 carries data and control signals between individual ones of the cores 110, a memory interface 140, and an input/output (I/O) interface 145. The core interconnect 120 can transmit and receive signals using electrical, optical, magnetic, or other suitable communication technology and can provide communication connections arranged according to a number of different topologies, depending on a particular desired configuration. For example, the core interconnect 120 can have a crossbar, a bus, a point-to-point bus, a ring, or other suitable topology. In some examples, any one of the cores 110 can be connected to any of the other cores, while in other examples, some cores are only connected to a subset of the other cores. For example, each core may only be connected to a nearest 4, 8, or 20 neighboring cores. The core interconnect 120 can be used to transmit input/output data to and from the cores, as well as transmit control signals and other information signals to and from the cores. For example, each of the cores 110 can receive and transmit semaphores that indicate the execution status of instructions currently being executed by each of the respective cores. In some examples, the core interconnect 120 is implemented as wires connecting the cores 110, and memory system, while in other examples, the core interconnect can include circuitry for multiplexing data signals on the interconnect wire(s), switch and/or routing components, including active signal drivers and repeaters, or other suitable circuitry. In some examples of the disclosed technology, signals transmitted within and to/from the processor 100 are not limited to full swing electrical digital signals, but the processor can be configured to include differential signals, pulsed signals, or other suitable signals for transmitting data and control signals.

In the example of FIG. 1, the memory interface 140 of the processor includes logic (such as a load-store queue and/or an L1 cache memory) that is used for local buffering of load and store data to memory and to connect to additional memory. For example, the additional memory can be located on another integrated circuit separate from the processor 100. As shown in FIG. 1 an external memory system 150 includes an L2 cache 152 and main memory 155. In some examples the L2 cache can be implemented using static RAM (SRAM) and the main memory 155 can be implemented using dynamic RAM (DRAM). In some examples the memory system 150 is included on the same integrated circuit as the other components of the processor 100. In some examples, the memory interface 140 includes a direct memory access (DMA) controller allowing transfer of blocks of data in memory without using register file(s) and/or the processor 100. In some examples, the memory interface 140 can include a memory management unit (MMU) for managing and allocating virtual memory, expanding the available main memory 155.

The I/O interface 145 includes circuitry for receiving and sending input and output signals to other components, such as hardware interrupts, system control signals, peripheral interfaces, co-processor control and/or data signals (e.g., signals for a graphics processing unit, floating point coprocessor, physics processing unit, digital signal processor, or other co-processing components), clock signals, semaphores, or other suitable I/O signals. The I/O signals may be synchronous or asynchronous. In some examples, all or a portion of the I/O interface is implemented using memory-mapped I/O techniques in conjunction with the memory interface 140.

The block-based processor 100 can also include a control unit 160. The control unit can communicate with the processing cores 110, the I/O interface 145, and the memory interface 140 via the core interconnect 120 or a side-band interconnect (not shown). The control unit 160 supervises operation of the processor 100. Operations that can be performed by the control unit 160 can include allocation and de-allocation of cores for performing instruction processing, control of input data and output data between any of the cores, register files, the memory interface 140, and/or the I/O interface 145, modification of execution flow, and verifying target location(s) of branch instructions, instruction headers, and other changes in control flow. The control unit 160 can also process hardware interrupts, and control reading and writing of special system registers, for example the program counter stored in one or more register file(s). In some examples of the disclosed technology, the control unit 160 is at least partially implemented using one or more of the processing cores 110, while in other examples, the control unit 160 is implemented using a non-block-based processing core (e.g., a general-purpose RISC processing core coupled to memory). In some examples, the control unit 160 is implemented at least in part using one or more of: hardwired finite state machines, programmable microcode, programmable gate arrays, or other suitable control circuits. In alternative examples, control unit functionality can be performed by one or more of the cores 110.

The control unit 160 includes a scheduler that is used to allocate instruction blocks to the processor cores 110. As used herein, scheduler allocation refers to hardware for directing operation of instruction blocks, including initiating instruction block mapping, fetching, decoding, execution, committing, aborting, idling, and refreshing an instruction block. In some examples, the hardware receives signals generated using computer-executable instructions to direct operation of the instruction scheduler. Processor cores 110 are assigned to instruction blocks during instruction block mapping. The recited stages of instruction operation are for illustrative purposes, and in some examples of the disclosed technology, certain operations can be combined, omitted, separated into multiple operations, or additional operations added.

The block-based processor 100 also includes a clock generator 170, which distributes one or more clock signals to various components within the processor (e.g., the cores 110, interconnect 120, memory interface 140, and I/O interface 145). In some examples of the disclosed technology, all of the components share a common clock, while in other examples different components use a different clock, for example, a clock signal having differing clock frequencies. In some examples, a portion of the clock is gated to allow power savings when some of the processor components are not in use. In some examples, the clock signals are generated using a phase-locked loop (PLL) to generate a signal of fixed, constant frequency and duty cycle. Circuitry that receives the clock signals can be triggered on a single edge (e.g., a rising edge) while in other examples, at least some of the receiving circuitry is triggered by rising and falling clock edges. In some examples, the clock signal can be transmitted optically or wirelessly.

### IV. Example Block-Based Processor Core

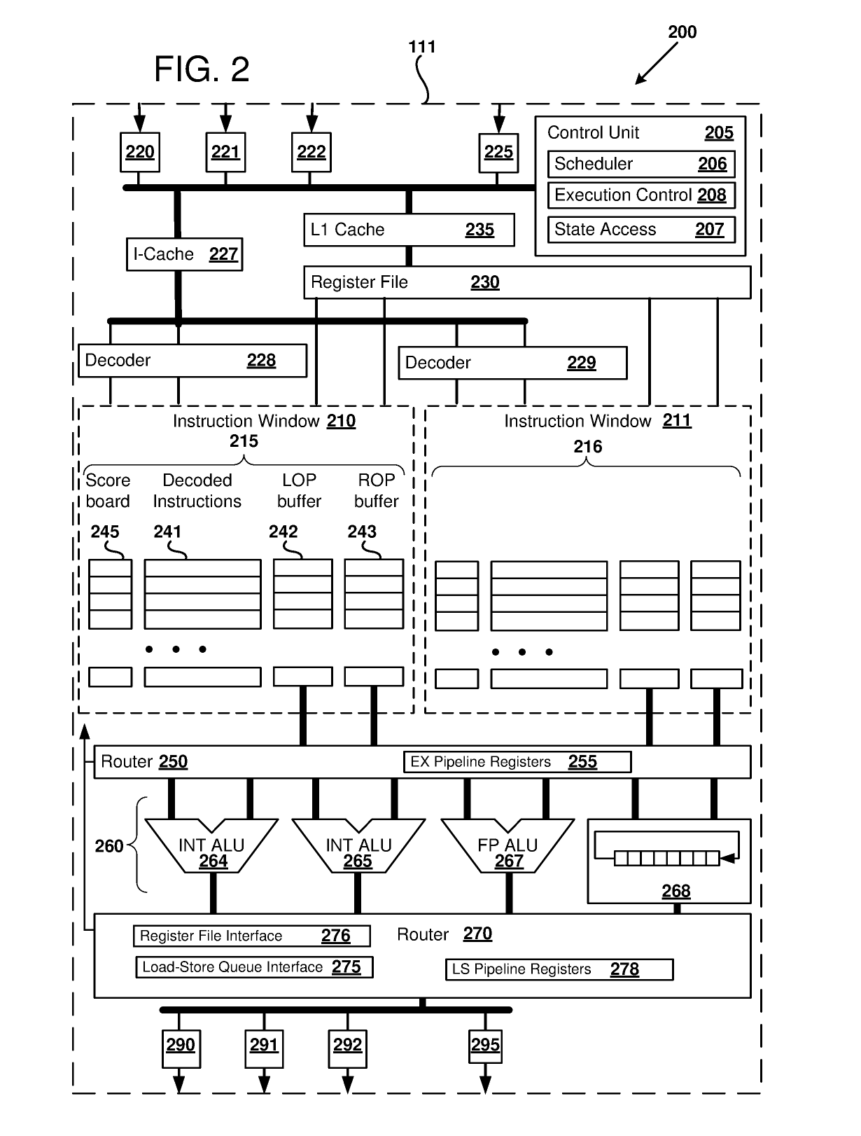

FIG. 2 is a block diagram 200 further detailing an example microarchitecture for the block-based processor 100, and in particular, an instance of one of the block-based processor cores (processor core 111), as can be used in certain examples of the disclosed technology. For ease of explanation, the exemplary block-based processor core 111 is illustrated with five stages: instruction fetch (IF), decode (DC), issue/operand fetch (IS), execute (EX), and memory/data access (LS). However, it will be readily understood by one of ordinary skill in the relevant art that modifications to the illustrated microarchitecture, such as adding/removing stages, adding/removing units that perform operations, and other implementation details can be modified to suit a particular application for a block-based processor.

In some examples of the disclosed technology, the processor core 111 can be used to execute and commit an instruction block of a program. An instruction block is an atomic collection of block-based-processor instructions that includes an instruction block header and a plurality of instructions. An “atomic” or “transactional” block can result in (1) either all or none of the effects on architectural state caused by the executing block being observed; and/or (2) all effects caused by the executing block are observable simultaneously, as if they all occurred at the same time. As will be discussed further below, the instruction block header can include information describing an execution mode of the instruction block and information that can be used to further define semantics of one or more of the plurality of instructions within the instruction block. Depending on the particular ISA and processor hardware used, the instruction block header can also be used, during execution of the instructions, to improve performance of executing an instruction block by, for example, allowing for early fetching of instructions and/or data, improved branch prediction, speculative execution, improved energy efficiency, and improved code compactness.

The instructions of the instruction block can be dataflow instructions that explicitly encode relationships between producer-consumer instructions of the instruction block. In particular, an instruction can communicate a result directly to a targeted instruction through an operand buffer that is reserved only for the targeted instruction. The intermediate results stored in the operand buffers are generally not visible to cores outside of the executing core because the block-atomic execution model only passes final results between the instruction blocks. The final results from executing the instructions of the atomic instruction block are made visible outside of the executing core when the instruction block is committed. Thus, the visible architectural state generated by each instruction block can appear as a single transaction outside of the executing core, and the intermediate results are typically not observable outside of the executing core.

As shown in FIG. 2, the processor core 111 includes a control unit 205, which can receive control signals from other cores and generate control signals to regulate core operation and schedules the flow of instructions within the core using an instruction scheduler 206. The control unit 205 can include state access logic 207 for examining core status and/or configuring operating modes of the processor core 111. The control unit 205 can include execution control logic 208 for generating control signals during one or more operating modes of the processor core 111. Operations that can be performed by the control unit 205 and/or instruction scheduler 206 can include allocation and de-allocation of cores for performing instruction processing, control of input data and output data between any of the cores, register files, the memory interface 140, and/or the I/O interface 145. The control unit 205 can also process hardware interrupts, and control reading and writing of special system registers, for example the program counter stored in one or more register file(s). In other examples of the disclosed technology, the control unit 205 and/or instruction scheduler 206 are implemented using a non-block-based processing core (e.g., a general-purpose RISC processing core coupled to memory). In some examples, the control unit 205, instruction scheduler 206, state access logic 207, and/or execution control logic 208 are implemented at least in part using one or more of: hardwired finite state machines, programmable microcode, programmable gate arrays, or other suitable control circuits.

The control unit 205 can decode the instruction block header to obtain information about the instruction block. For example, execution modes of the instruction block can be specified in the instruction block header though various execution flags. The decoded execution mode can be stored in registers of the execution control logic 208. Based on the execution mode, the execution control logic 208 can generate control signals to regulate core operation and schedule the flow of instructions within the core 111, such as by using the instruction scheduler 206. For example, during a default execution mode, the execution control logic 208 can sequence the instructions of one or more instruction blocks executing on one or more instruction windows (e.g., 210, 211) of the processor core 111. Specifically, each of the instructions can be sequenced through the instruction fetch, decode, operand fetch, execute, and memory/data access stages so that the instructions of an instruction block can be pipelined and executed in parallel. The instructions are ready to execute when their operands are available, and the instruction scheduler 206 can select the order in which to execute the instructions.

The state access logic 207 can include an interface for other cores and/or a processor-level control unit (such as the control unit 160 of FIG. 1) to communicate with and access state of the core 111. For example, the state access logic 207 can be connected to a core interconnect (such as the core interconnect 120 of FIG. 1) and the other cores can communicate via control signals, messages, reading and writing registers, and the like.

The state access logic 207 can include control state registers or other logic for modifying and/or examining modes and/or status of an instruction block and/or core status. As an example, the core status can indicate whether an instruction block is mapped to the core 111 or an instruction window (e.g., instruction windows 210, 211) of the core 111, whether an instruction block is resident on the core 111, whether an instruction block is executing on the core 111, whether the instruction block is ready to commit, whether the instruction block is performing a commit, and whether the instruction block is idle. As another example, the status of an instruction block can include a token or flag indicating the instruction block is the oldest instruction block executing and a flag indicating the instruction block is executing speculatively.

The control state registers (CSRs) can be mapped to unique memory locations that are reserved for use by the block-based processor. For example, CSRs of the control unit 160 (FIG. 1) can be assigned to a first range of addresses, CSRs of the memory interface 140 (FIG. 1) can be assigned to a second range of addresses, a first processor core can be assigned to a third range of addresses, a second processor core can be assigned to a fourth range of addresses, and so forth. In one embodiment, the CSRs can be accessed using general purpose memory read and write instructions of the block-based processor. Additionally or alternatively, the CSRs can be accessed using specific read and write instructions (e.g., the instructions have opcodes different from the memory read and write instructions) for the CSRs. Thus, one core can examine the configuration state of a different core by reading from an address corresponding to the different core's CSRs. Similarly, one core can modify the configuration state of a different core by writing to an address corresponding to the different core's CSRs. Additionally or alternatively, the CSRs can be accessed by shifting commands into the state access logic 207 through serial scan chains. In this manner, one core can examine the state access logic 207 of a different core and one core can modify the state access logic 207 or modes of a different core.

Each of the instruction windows 210 and 211 can receive instructions and data from one or more of input ports 220, 221, and 222 which connect to an interconnect bus and instruction cache 227, which in turn is connected to the instruction decoders 228 and 229. Additional control signals can also be received on an additional input port 225. Each of the instruction decoders 228 and 229 decodes instructions for an instruction block and stores the decoded instructions within a memory store 215 and 216 located in each respective instruction window 210 and 211.

The processor core 111 further includes a register file 230 coupled to an L1 (level one) cache 235. The register file 230 stores data for registers defined in the block-based processor architecture, and can have one or more read ports and one or more write ports. For example, a register file may include two or more write ports for storing data in the register file, as well as having a plurality of read ports for reading data from individual registers within the register file. In some examples, a single instruction window (e.g., instruction window 210) can access only one port of the register file at a time, while in other examples, the instruction window 210 can access one read port and one write port, or can access two or more read ports and/or write ports simultaneously. In some examples, the register file 230 can include 64 registers, each of the registers holding a word of 32 bits of data. (This application will refer to 32-bits of data as a word, unless otherwise specified.) In some examples, some of the registers within the register file 230 may be allocated to special purposes. For example, some of the registers can be dedicated as system registers examples of which include registers storing constant values (e.g., an all zero word), program counter(s) (PC), which indicate the current address of a program thread that is being executed, a physical core number, a logical core number, a core assignment topology, core control flags, a processor topology, or other suitable dedicated purpose. In some examples, there are multiple program counter registers, one or each program counter, to allow for concurrent execution of multiple execution threads across one or more processor cores and/or processors. In some examples, program counters are implemented as designated memory locations instead of as registers in a register file. In some examples, use of the system registers may be restricted by the operating system or other supervisory computer instructions. In some examples, the register file 230 is implemented as an array of flip-flops, while in other examples, the register file can be implemented using latches, SRAM, or other forms of memory storage. The ISA specification for a given processor, for example processor 100, specifies how registers within the register file 230 are defined and used.

In some examples, the register file 230 includes a transactional register file and associated logic for communicating register values and register status information among a plurality of the processor cores. In some examples, individual register files associated with a processor core can be combined to form a distributed register file, statically or dynamically, depending on the processor ISA and configuration. For example, each processor core can be configured to execute all of the instruction blocks within a thread and the register file values can be retained within the processor cores. As another example, multiple processors can be logically fused together to execute the instruction blocks of a thread, and the register file values can be distributed among the different cores executing the thread. By fusing the processor cores, more instructions can be executed in parallel to potentially increase a single-threaded performance of the processor 100.

As shown in FIG. 2, the memory store 215 of the instruction window 210 includes a number of decoded instructions 241, a left operand (LOP) buffer 242, a right operand (ROP) buffer 243, and an instruction scoreboard 245. In some examples of the disclosed technology, each instruction of the instruction block is decomposed into a row of decoded instructions, left and right operands, and scoreboard data, as shown in FIG. 2. The decoded instructions 241 can include partially- or fully-decoded versions of instructions stored as bit-level control signals. The operand buffers 242 and 243 store operands (e.g., register values received from the register file 230, data received from memory, immediate operands coded within an instruction, operands calculated by an earlier-issued instruction, or other operand values) until their respective decoded instructions are ready to execute. Instruction operands are read from the operand buffers 242 and 243, not the register file.

The memory store 216 of the second instruction window 211 stores similar instruction information (decoded instructions, operands, and scoreboard) as the memory store 215, but is not shown in FIG. 2 for the sake of simplicity. Instruction blocks can be executed by the second instruction window 211 concurrently or sequentially with respect to the first instruction window, subject to ISA constraints and as directed by the control unit 205.

In some examples of the disclosed technology, front-end pipeline stages IF and DC can run decoupled from the back-end pipelines stages (IS, EX, LS). In one embodiment, the control unit can fetch and decode two instructions per clock cycle into each of the instruction windows 210 and 211. In alternative embodiments, the control unit can fetch and decode one, four, or another number of instructions per clock cycle into a corresponding number of instruction windows. The control unit 205 provides instruction window dataflow scheduling logic to monitor the ready state of each decoded instruction's inputs (e.g., each respective instruction's predicate(s) and operand(s) using the scoreboard 245. When all of the inputs for a particular decoded instruction are ready, the instruction is ready to issue. The control logic 205 then initiates execution of one or more next instruction(s) (e.g., the lowest numbered ready instruction) each cycle and its decoded instruction and input operands are sent to one or more of functional units 260 for execution. The decoded instruction can also encode a number of ready events. The scheduler in the control logic 205 accepts these and/or events from other sources and updates the ready state of other instructions in the window. Thus execution proceeds, starting with the processor core's 111 ready zero input instructions, instructions that are targeted by the zero input instructions, and so forth.

The decoded instructions 241 need not execute in the same order in which they are arranged within the memory store 215 of the instruction window 210. Rather, the instruction scoreboard 245 is used to track dependencies of the decoded instructions and, when the dependencies have been met, the associated individual decoded instruction is scheduled for execution. For example, a reference to a respective instruction can be pushed onto a ready queue when the dependencies have been met for the respective instruction, and instructions can be scheduled in a first-in first-out (FIFO) order from the ready queue. Information stored in the scoreboard 245 can include, but is not limited to, the associated instruction's execution predicate (such as whether the instruction is waiting for a predicate bit to be calculated and whether the instruction executes if the predicate bit is true or false), availability of operands to the instruction, or other prerequisites required before executing the associated individual instruction.

In one embodiment, the scoreboard 245 can include decoded ready state, which is initialized by the instruction decoder 228, and active ready state, which is initialized by the control unit 205 during execution of the instructions. For example, the decoded ready state can encode whether a respective instruction has been decoded, awaits a predicate and/or some operand(s), perhaps via a broadcast channel, or is immediately ready to issue. The active ready state can encode whether a respective instruction awaits a predicate and/or some operand(s), is ready to issue, or has already issued. The decoded ready state can cleared on a block reset or a block refresh. Upon branching to a new instruction block, the decoded ready state and the active ready state is cleared (a block or core reset). However, when an instruction block is re-executed on the core, such as when it branches back to itself (a block refresh), only active ready state is cleared. Block refreshes can occur immediately (when an instruction block branches to itself) or after executing a number of other intervening instruction blocks. The decoded ready state for the instruction block can thus be preserved so that it is not necessary to re-fetch and decode the block's instructions. Hence, block refresh can be used to save time and energy in loops and other repeating program structures.

The number of instructions that are stored in each instruction window generally corresponds to the number of instructions within an instruction block. In some examples, the number of instructions within an instruction block can be 32, 64, 128, 1024, or another number of instructions. In some examples of the disclosed technology, an instruction block is allocated across multiple instruction windows within a processor core. In some examples, the instruction windows 210, 211 can be logically partitioned so that multiple instruction blocks can be executed on a single processor core. For example, one, two, four, or another number of instruction blocks can be executed on one core. The respective instruction blocks can be executed concurrently or sequentially with each other.

Instructions can be allocated and scheduled using the control unit 205 located within the processor core 111. The control unit 205 orchestrates fetching of instructions from memory, decoding of the instructions, execution of instructions once they have been loaded into a respective instruction window, data flow into/out of the processor core 111, and control signals input and output by the processor core. For example, the control unit 205 can include the ready queue, as described above, for use in scheduling instructions. The instructions stored in the memory store 215 and 216 located in each respective instruction window 210 and 211 can be executed atomically. Thus, updates to the visible architectural state (such as writes to the register file 230 and the memory) affected by the executed instructions can be buffered locally within the core until the instructions are committed. The control unit 205 can determine when instructions are ready to be committed, sequence the commit logic, and issue a commit signal. For example, a commit phase for an instruction block can begin when all register writes are buffered, all writes to memory are buffered, and a branch target is calculated. The instruction block can be committed when updates to the visible architectural state are complete. For example, an instruction block can be committed when the register writes are written to the register file, the stores are sent to a load-store unit or memory controller, and the commit signal is generated. The control unit 205 also controls, at least in part, allocation of functional units 260 to each of the respective instructions windows.

As shown in FIG. 2, a first router 250, which has a number of execution pipeline registers 255, is used to send data from either of the instruction windows 210 and 211 to one or more of the functional units 260, which can include but are not limited to, integer ALUs (arithmetic logic units) (e.g., integer ALUs 264 and 265), floating point units (e.g., floating point ALU 267), shift/rotate logic (e.g., barrel shifter 268), or other suitable execution units, which can including graphics functions, physics functions, and other mathematical operations. Data from the functional units 260 can then be routed through a second router 270 to outputs 290, 291, and 292, routed back to an operand buffer (e.g. LOP buffer 242 and/or ROP buffer 243), or fed back to another functional unit, depending on the requirements of the particular instruction being executed. The second router 270 can include a load-store queue interface 275, a load-store pipeline register 278, and a register file interface 276. The load-store queue interface 275 can be used to communicate with a load-store queue that is shared by multiple processor cores. The load-store queue can be used to process memory instructions (e.g., load instructions and store instructions). The load-store pipeline register 278 can be used to store inputs and outputs to the load-store queue. The register file interface 276 can be used to communicate with the register file 230 and/or register file interfaces on other processor cores. For example, the register file interface 276 can route an output generated for an instruction by one of the functional units 260 to the register file 230 in a non-fused mode and to the register file of another processor core in a fused mode. In particular and as described in more detail below, the register file interface can generate register-write messages which can be used to send register values to another processor core. In this manner, the register file can be distributed and shared by multiple processor cores executing a thread of a program.

The core also includes control outputs 295 which are used to indicate, for example, when execution of all of the instructions for one or more of the instruction windows 210 or 211 has completed. When execution of an instruction block is complete, the instruction block is designated as “committed” and signals from the control outputs 295 can in turn can be used by other cores within the block-based processor 100 and/or by the control unit 160 to initiate scheduling, fetching, and execution of other instruction blocks. Both the first router 250 and the second router 270 can send data back to the instruction (for example, as operands for other instructions within an instruction block).

As will be readily understood to one of ordinary skill in the relevant art, the components within an individual core are not limited to those shown in FIG. 2, but can be varied according to the requirements of a particular application. For example, a core may have fewer or more instruction windows, a single instruction decoder might be shared by two or more instruction windows, and the number of and type of functional units used can be varied, depending on the particular targeted application for the block-based processor. Other considerations that apply in selecting and allocating resources with an instruction core include performance requirements, energy usage requirements, integrated circuit die, process technology, and/or cost.

It will be readily apparent to one of ordinary skill in the relevant art that trade-offs can be made in processor performance by the design and allocation of resources within the instruction window (e.g., instruction window 210) and control logic 205 of the processor cores 110. The area, clock period, capabilities, and limitations substantially determine the realized performance of the individual cores 110 and the throughput of the block-based processor cores 110.

The instruction scheduler 206 can have diverse functionality. In certain higher performance examples, the instruction scheduler is highly concurrent. For example, each cycle, the decoder(s) write instructions' decoded ready state and decoded instructions into one or more instruction windows, selects the next instruction to issue, and, in response the back end sends ready events—either target-ready events targeting a specific instruction's input slot (predicate, left operand, right operand, etc.), or broadcast-ready events targeting all instructions. The per-instruction ready state bits, together with the decoded ready state can be used to determine that the instruction is ready to issue.

In some examples, the instruction scheduler 206 is implemented using storage (e.g., first-in first-out (FIFO) queues, content addressable memories (CAMs)) storing data indicating information used to schedule execution of instruction blocks according to the disclosed technology. For example, data regarding instruction dependencies, transfers of control, speculation, branch prediction, and/or data loads and stores are arranged in storage to facilitate determinations in mapping instruction blocks to processor cores. For example, instruction block dependencies can be associated with a tag that is stored in a FIFO or CAM and later accessed by selection logic used to map instruction blocks to one or more processor cores. In some examples, the instruction scheduler 206 is implemented using a general purpose processor coupled to memory, the memory being configured to store data for scheduling instruction blocks. In some examples, instruction scheduler 206 is implemented using a special purpose processor or using a block-based processor core coupled to the memory. In some examples, the instruction scheduler 206 is implemented as a finite state machine coupled to the memory. In some examples, an operating system executing on a processor (e.g., a general purpose processor or a block-based processor core) generates priorities, predictions, and other data that can be used at least in part to schedule instruction blocks with the instruction scheduler 206. As will be readily apparent to one of ordinary skill in the relevant art, other circuit structures, implemented in an integrated circuit, programmable logic, or other suitable logic can be used to implement hardware for the instruction scheduler 206.

In some cases, the scheduler 206 accepts events for target instructions that have not yet been decoded and must also inhibit reissue of issued ready instructions. Instructions can be non-predicated, or predicated (based on a true or false condition). A predicated instruction does not become ready until it is targeted by another instruction's predicate result, and that result matches the predicate condition. If the associated predicate does not match, the instruction never issues. In some examples, predicated instructions may be issued and executed speculatively. In some examples, a processor may subsequently check that speculatively issued and executed instructions were correctly speculated. In some examples a misspeculated issued instruction and the specific transitive closure of instructions in the block that consume its outputs may be re-executed, or misspeculated side effects annulled. In some examples, discovery of a misspeculated instruction leads to the complete roll back and re-execution of an entire block of instructions.

### V. Example Stream of Instruction Blocks

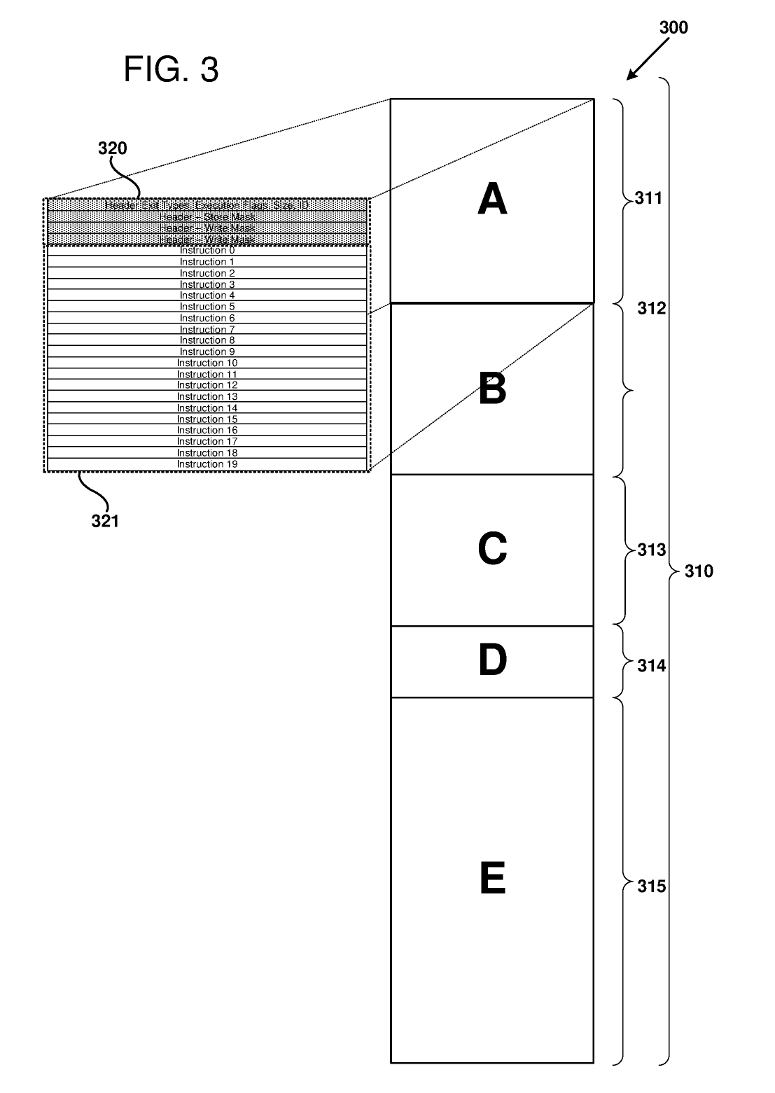

Turning now to the diagram 300 of FIG. 3, a portion 310 of a stream of block-based instructions, including a number of variable length instruction blocks 311-315 (A-E) is illustrated. The stream of instructions can be used to implement a user application, system services, or for any other suitable use. For example, a block-based compiler can compile source code of a program and generate the stream of instructions divided into the instruction blocks 311-315. The individual instructions of the instruction block can be emitted in a sequential order that can be different from a program order or an execution order. The individual instructions of the instruction block can include an instruction identifier (IID) that is encoded within a field of the instruction or based on the sequential order of the instruction within the instruction block. The compiler can also generate header information describing characteristics of each instruction block, such as a make-up of load and/or store instructions and a list of registers that are written, for example.

In the example shown in FIG. 3, each instruction block begins with an instruction header, which is followed by a varying number of instructions. For example, the instruction block 311 includes a header 320 and twenty instructions 321. The particular instruction header 320 illustrated includes a number of data fields that control, in part, execution of the instructions within the instruction block, and also allow for improved performance enhancement techniques including, for example branch prediction, speculative execution, lazy evaluation, and/or other techniques. The instruction header 320 also includes an ID bit which indicates that the header is an instruction header and not an instruction. The instruction header 320 also includes an indication of the instruction block size. The instruction block size can be in larger chunks of instructions than one, for example, the number of 4-instruction chunks contained within the instruction block. In other words, the size of the block is shifted 4 bits in order to compress header space allocated to specifying instruction block size. Thus, a size value of 0 indicates a minimally-sized instruction block which is a block header followed by four instructions. In some examples, the instruction block size is expressed as a number of bytes, as a number of words, as a number of n-word chunks, as an address, as an address offset, or using other suitable expressions for describing the size of instruction blocks. In some examples, the instruction block size is indicated by a terminating bit pattern in the instruction block header and/or footer.

The instruction block header 320 can also include execution flags, which indicate special instruction execution requirements. For example, branch prediction or memory dependence prediction can be inhibited for certain instruction blocks, depending on the particular application.

In some examples of the disclosed technology, the instruction header 320 includes one or more identification bits that indicate that the encoded data is an instruction header. For example, in some block-based processor ISAs, a single ID bit in the least significant bit space is always set to the binary value 1 to indicate the beginning of a valid instruction block. In other examples, different bit encodings can be used for the identification bit(s). In some examples, the instruction header 320 includes information indicating a particular version of the ISA for which the associated instruction block is encoded.

The block instruction header can also include a number of block exit types for use in, for example, branch prediction, control flow determination, and/or bad jump detection. The exit type can indicate what the type of branch instructions are, for example: sequential branch instructions, which point to the next contiguous instruction block in memory; offset instructions, which are branches to another instruction block at a memory address calculated relative to an offset; subroutine calls, or subroutine returns. By encoding the branch exit types in the instruction header, the branch predictor can begin operation, at least partially, before branch instructions within the same instruction block have been fetched and/or decoded.

The instruction block header 320 also includes a store mask which identifies the load-store queue identifiers that are assigned to store operations for the instruction block. The instruction block header can also include a write mask, which identifies which global register(s) the associated instruction block may write. The associated register file will receive a write instruction or a null-write instruction to each entry before the instruction block can successfully complete. In some examples a block-based processor architecture can include not only scalar instructions, but also single-instruction multiple-data (SIMD) instructions, that allow for operations with a larger number of data operands within a single instruction.

### VI. Example Block Instruction Target Encoding

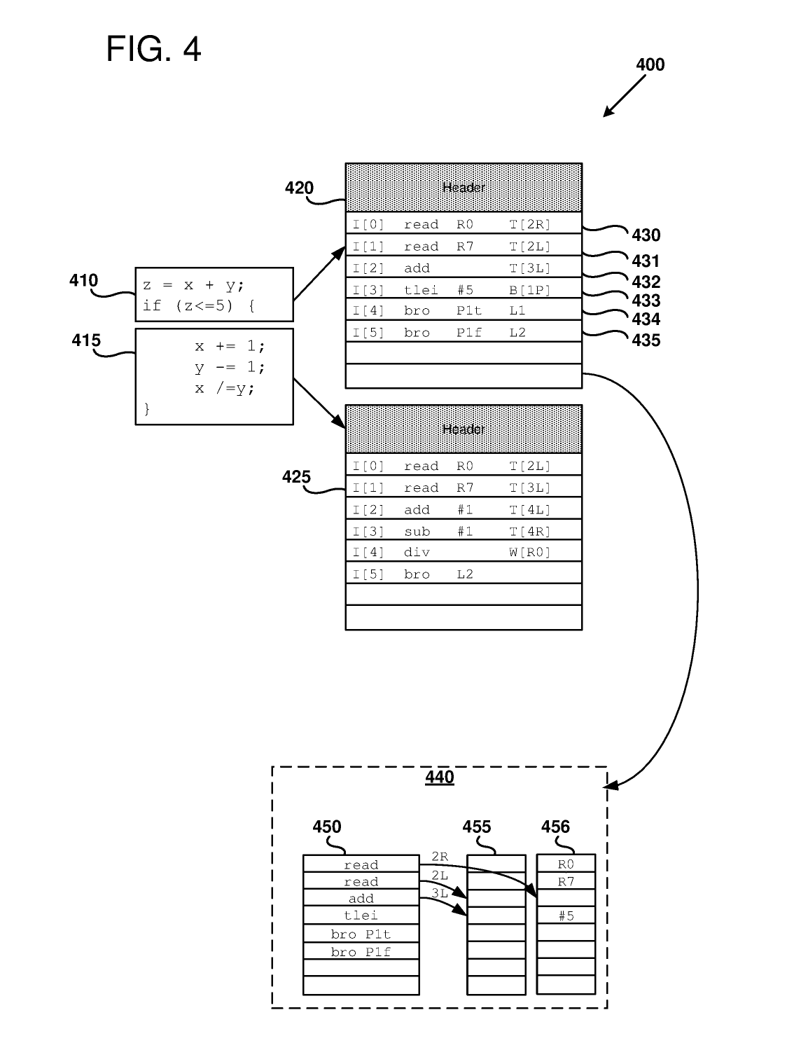

FIG. 4 is a diagram 400 depicting an example of two portions 410 and 415 of C language source code and their respective instruction blocks 420 and 425 (in assembly language), illustrating how block-based instructions can explicitly encode their targets. The high-level C language source code can be translated to the low-level assembly language and machine code by a compiler whose target is a block-based processor. A high-level language can abstract out many of the details of the underlying computer architecture so that a programmer can focus on functionality of the program. In contrast, the machine code encodes the program according to the target computer's ISA so that it can be executed on the target computer, using the computer's hardware resources. Assembly language is a human-readable form of machine code.

In the following examples, the assembly language instructions use the following nomenclature: “I[<number>] specifies the number of the instruction within the instruction block where the numbering begins at zero for the instruction following the instruction header and the instruction number is incremented for each successive instruction; the operation of the instruction (such as READ, ADDI, DIV, and the like) follows the instruction number; optional values (such as the immediate value 1) or references to registers (such as R0 for register 0) follow the operation; and optional targets that are to receive the results of the instruction follow the values and/or operation. Each of the targets can be to another instruction, a broadcast channel to other instructions, or a register that can be visible to another instruction block when the instruction block is committed. An example of an instruction target is T[1R] which targets the right operand of instruction 1. An example of a register target is W[R0], where the target is written to register 0.

In the diagram 400, the first two READ instructions 430 and 431 (with IIDs of 0 and 1, respectively) of the instruction block 420 target the right (T[2R]) and left (T[2L]) operands, respectively, of the ADD instruction 432 (with IID=2). In the illustrated ISA, the read instruction is the only instruction that reads from the global or inter-block register file; however any instruction can target, the global register file. When the ADD instruction 432 receives the result of both register reads it will become ready and execute.

When the TLEI (test-less-than-equal-immediate) instruction 433 receives its single input operand from the ADD, it will become ready and execute. The test then produces a predicate operand that is broadcast on channel one (B [1P]) to all instructions listening on the broadcast channel, which in this example are the two predicated branch instructions (BRO P1t 434 and BRO P1f 435). In the assembly language of the diagram 400, “P1f” indicates the instruction is predicated (the “P”) on a false result (the “f”) being transmitted on broadcast channel 1 (the “1”), and “P1t” indicates the instruction is predicated on a true result being transmitted on broadcast channel 1. The branch that receives a matching predicate will fire.

A dependence graph 440 for the instruction block 420 is also illustrated, as an array 450 of instruction nodes and their corresponding operand targets 455 and 456. This illustrates the correspondence between the block instructions 420, the corresponding instruction window entries, and the underlying dataflow graph represented by the instructions. Here decoded instructions READ 430 and READ 431 are ready to issue, as they have no input dependencies. As they issue and execute, the values read from registers R6 and R7 are written into the right and left operand buffers of ADD 432, marking the left and right operands of ADD 432 “ready.” As a result, the ADD 432 instruction becomes ready, issues to an ALU, executes, and the sum is written to the left operand of TLEI 433.

As a comparison, a conventional out-of-order RISC or CISC processor would dynamically build the dependence graph at runtime, using additional hardware complexity, power, area and reducing clock frequency and performance. However, the dependence graph is known statically at compile time and an EDGE compiler can directly encode the producer-consumer relations between the instructions through the ISA, freeing the microarchitecture from rediscovering them dynamically. This can potentially enable a simpler microarchitecture, reducing area, power and boosting frequency and performance.

### VII. Example Block-Based Instruction Formats

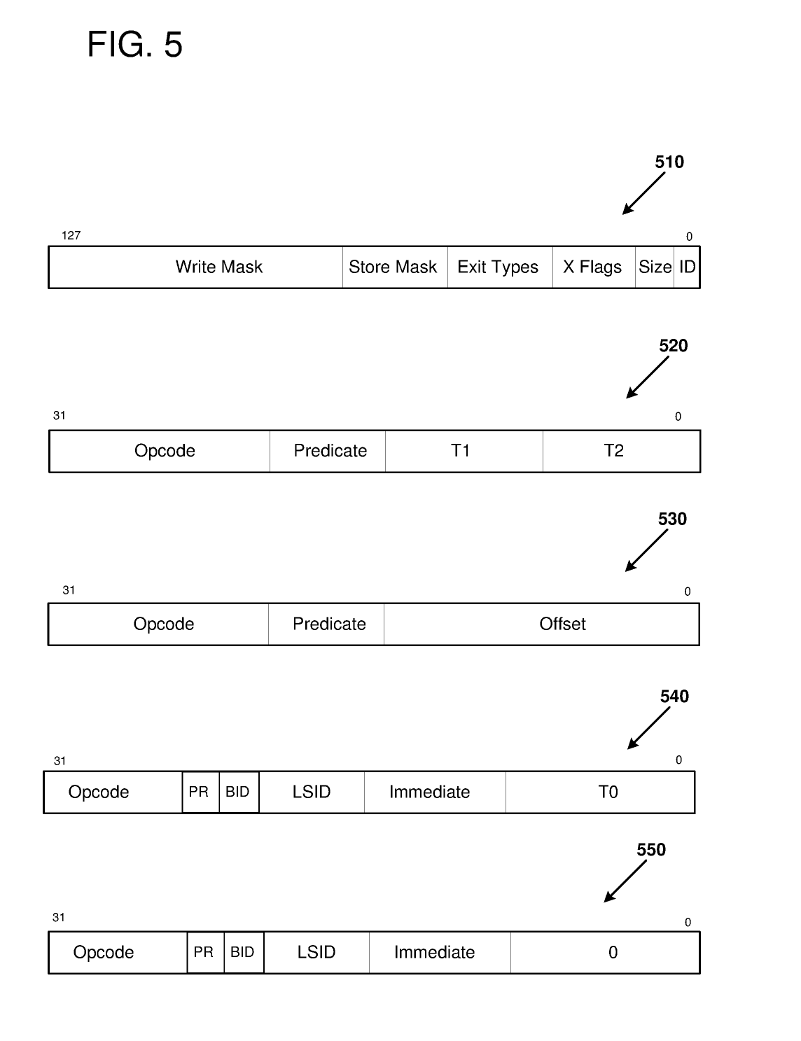

FIG. 5 is a diagram illustrating generalized examples of instruction formats for an instruction header 510, a generic instruction 520, a branch instruction 530, a load instruction 540, and a store instruction 550. Each of the instruction headers or instructions is labeled according to the number of bits. For example the instruction header 510 includes four 32-bit words and is labeled from its least significant bit (lsb) (bit 0) up to its most significant bit (msb) (bit 127). As shown, the instruction header includes a write mask field, a store mask field, a number of exit type fields, a number of execution flag fields (X flags), an instruction block size field, and an instruction header ID bit (the least significant bit of the instruction header).

The execution flag fields can indicate special instruction execution modes. For example, an “inhibit branch predictor” flag can be used to inhibit branch prediction for the instruction block when the flag is set. As another example, an “inhibit memory dependence prediction” flag can be used to inhibit memory dependence prediction for the instruction block when the flag is set. As another example, a “break after block” flag can be used to halt an instruction thread and raise an interrupt when the instruction block is committed. As another example, a “break before block” flag can be used to halt an instruction thread and raise an interrupt when the instruction block header is decoded and before the instructions of the instruction block are executed.

The exit type fields include data that can be used to indicate the types of control flow and/or synchronization instructions encoded within the instruction block. For example, the exit type fields can indicate that the instruction block includes one or more of the following: sequential branch instructions, offset branch instructions, indirect branch instructions, call instructions, return instructions, and/or break instructions. In some examples, the branch instructions can be any control flow instructions for transferring control flow between instruction blocks, including relative and/or absolute addresses, and using a conditional or unconditional predicate. The exit type fields can be used for branch prediction and speculative execution in addition to determining implicit control flow instructions. In some examples, up to six exit types can be encoded in the exit type fields, and the correspondence between fields and corresponding explicit or implicit control flow instructions can be determined by, for example, examining control flow instructions in the instruction block.

The illustrated generic block instruction 520 is stored as one 32-bit word and includes an opcode field, a predicate field, an optional broadcast ID field (BID), a first target field (T1), and a second target field (T2). For instructions with more consumers than target fields, a compiler can build a fanout tree using move instructions, or it can assign high-fanout instructions to broadcasts. Broadcasts support sending an operand over a lightweight network to any number of consumer instructions in a core. A broadcast identifier can be encoded in the generic block instruction 520.

While the generic instruction format outlined by the generic instruction 520 can represent some or all instructions processed by a block-based processor, it will be readily understood by one of skill in the art that, even for a particular example of an ISA, one or more of the instruction fields may deviate from the generic format for particular instructions. The opcode field specifies the length or width of the instruction 520 and the operation(s) performed by the instruction 520, such as memory load/store, register read/write, add, subtract, multiply, divide, shift, rotate, nullify, system operations, or other suitable instructions.

A predicated instruction is an instruction that conditionally executes based on whether a result associated with the instruction matches a predicate test value. The predicate field specifies the condition under which the instruction will execute. For example, the predicate field can specify the value “true,” and the instruction will only execute if a corresponding condition flag matches the specified predicate value. In some examples, the predicate field specifies, at least in part, a field, operand, or other resource which is used to compare the predicate, while in other examples, the execution is predicated on a flag set by a previous instruction (e.g., the preceding instruction in the instruction block). In some examples, the predicate field can specify that the instruction will always, or never, be executed. Thus, use of the predicate field can allow for denser object code, improved energy efficiency, and improved processor performance, by reducing the number of branch instructions.

As a specific example of a predicated instruction, a result can be delivered to an operand of the predicated instruction from another instruction, and a predicate test value can be encoded in a field of the predicated instruction. As a specific example, the instruction 520 can be a predicated instruction when one or more bits of the predicate field (PR) are non-zero. For example, the predicate field can be two bits wide where one bit is used to indicate that the instruction is predicated and one bit is used to indicate the predicate test value. Specifically, the encodings “00” can indicate the instruction 520 is not predicated; “10” can indicate the instruction 520 is predicated on a false condition (e.g., the predicate test value is a “0”); “11” can indicate the instruction 520 is predicated on a true condition (e.g., the predicate test value is a “0”); and “10” can be reserved. Thus, a two-bit predicate field can be used to compare a received result to a true or false condition. A wider predicate field can be used to compare the received result to a larger number.

In another example, the result to be compared to the predicate test value can be passed to the instruction via one or more broadcast operands or channels. The broadcast channel of the predicate can be identified within the instruction 520 using a broadcast identifier field (BID). For example, the broadcast identifier field can be two-bits wide to encode four possible broadcast channels on which to receive the value to compare to the predicate test value. As a specific example, if the value received on the identified broadcast channel matches the predicate test value, the instruction 520 is executed. However, if the value received on the identified broadcast channel does not match the predicate test value, the instruction 520 is not executed.

The target fields T1 and T2 can specify targets to which the results of the block-based instruction are sent. The targets can include operands of other instructions within the instruction block and registers of a register file. The individual registers of the register file can be identified using a register identifier (RID). As one example, an ADD instruction at instruction slot 5 can specify that its computed result will be sent to instructions at slots 3 and 10. As another example, an ADD instruction at instruction slot 5 can specify that its computed result will be sent to the register having RID=10 (register 10 or R10) of the register file. Depending on the particular instruction and ISA, one or both of the illustrated target fields can be replaced by other information, for example, the first target field T1 can be replaced by an immediate operand, an additional opcode, specify two targets, etc.

The branch instruction 530 includes an opcode field, a predicate field, a broadcast ID field (BID), and an offset field. The opcode and predicate fields are similar in format and function as described regarding the generic instruction. The offset can be expressed in units of four instructions, thus extending the memory address range over which a branch can be executed. The predicate shown with the generic instruction 520 and the branch instruction 530 can be used to avoid additional branching within an instruction block. For example, execution of a particular instruction can be predicated on the result of a previous instruction (e.g., a comparison of two operands). If the predicate is false, the instruction will not commit values calculated by the particular instruction. If the predicate value does not match the required predicate, the instruction does not issue. For example, a BRO_F (predicated false) instruction will issue if it is sent a false predicate value.

It should be readily understood that, as used herein, the term “branch instruction” is not limited to changing program execution to a relative memory location, but also includes jumps to an absolute or symbolic memory location, subroutine calls and returns, and other instructions that can modify the execution flow. In some examples, the execution flow is modified by changing the value of a system register (e.g., a program counter PC or instruction pointer), while in other examples, the execution flow can be changed by modifying a value stored at a designated location in memory. In some examples, a jump register branch instruction is used to jump to a memory location stored in a register. In some examples, subroutine calls and returns are implemented using jump and link and jump register instructions, respectively.

The load instruction 540 is used for retrieving data stored at a target address of memory so that the data can be used by a processor core. The target address of the data can be calculated dynamically at runtime. For example, the address can be a sum of an operand of the load instruction 540 and an immediate field of the load instruction 540. As another example, the address can be a sum of an operand of the load instruction 540 and a sign-extended and/or shifted immediate field of the load instruction 540. As another example, the address of the data can be a sum of two operands of the load instruction 540. The load instruction 540 can include a load-store identifier field (LSID) to provide a relative program ordering of the load within an instruction block. For example, the compiler can assign an LSID to each load and store of the instruction block at compile-time. The ISA can specify a maximum number of load and store instructions per instruction block. A bit-width of the LSID field can be sized to uniquely identify all of the different load and store instructions of the instruction block. For example, a 5-bit width for the LSID field can uniquely identify 2⁵ or 32 unique load and store instructions.

The load instruction 540 can specify various different amounts and types of data to be retrieved and/or formatted. For example, the data can be formatted as a signed or unsigned value and the amount or size of the data retrieved can vary. Different opcodes can be used to identify the type of load instruction 540, such as as a load unsigned byte, load signed byte, load double-word, load unsigned half-word, load signed half-word, load unsigned word, and load signed word, for example. The output of the load instruction 540 can be directed to a target instruction as indicated by a target field (T0). The load instruction 540 can be predicated similar to the instruction 520 using a predicate field and/or a broadcast identifier field.

As a specific example of a 32-bit load instruction 540, the opcode field can be encoded in bits [31:25]; the predicate field can be encoded in bits [24:23]; the broadcast identifier field can be encoded in bits [22:21]; the LSID field can be encoded in bits [20:16]; the immediate field can be encoded in bits [15:9]; and the target field can be encoded in bits [8:0].

The store instruction 550 is used for storing data at a target address of the memory. The target address of the data can be calculated dynamically at runtime. For example, the address can be a sum of a first operand of the store instruction 550 and an immediate field of the store instruction 550. As another example, the address can be a sum of an operand of the store instruction 550 and a sign-extended and/or shifted immediate field of the store instruction 550. As another example, the address of the data can be a sum of two operands of the store instruction 550. The store instruction 550 can include a load-store identifier field (LSID) to provide a relative program ordering of the store within an instruction block. The amount of data to be stored can vary based on an opcode of the store instruction 550, such as a store byte, store half-word, store word, and store double-word, for example. The data to be stored at the memory location can be input from a second operand of the store instruction 550. The second operand can be generated by another instruction or encoded as a field of the store instruction 550. The store instruction 550 can be predicated similar to the instruction 520 using a predicate field and/or a broadcast identifier field.

As a specific example of a 32-bit store instruction 550, the opcode field can be encoded in bits [31:25]; the predicate field can be encoded in bits [24:23]; the broadcast identifier field can be encoded in bits [22:21]; the LSID field can be encoded in bits [20:16]; and the immediate field can be encoded in bits [15:9]. The bits [8:1] can be reserved for additional functions or for future use.

The use of predicated instructions can lead to conditions where some of the instructions are not executed. For example, a first group of instructions can be predicated on a true value and a second group of instructions can be predicated on a false value. Thus, only one of the groups of instructions can execute since a variable cannot be both true and false. In one embodiment, the compiler can identify certain conditions for an instruction block to complete. For example, the compiler can create a store mask which identifies all store instructions that may be executed by the instruction block and a write mask which identifies all register write instructions that may be executed by the instruction block. The identified store and/or write instructions can be tracked during execution. However, the different groups of instructions may include a different number of tracked instructions or different targets. As a specific example, an instruction block may write to registers 1, 6, and 8. A first group of predicated instructions can include instructions that write to registers 1 and 6 and the second group of predicated instructions can include an instruction that writes to register 8. The first group and the second group can be mutually exclusive so if the first group executes, only registers 1 and 6 are written and if the second group executes, only register 8 is written. Tracking logic that expected all of the registers 1, 6, and 8 to be written would wait forever (or until a timeout) unless additional actions are taken to notify the tracking logic that the registers predicated on non-matched values will not be executed.

A nullify instruction can be used to indicate that a load or store instruction or a register read or write will not be executed, such as when the instructions are predicated on non-matched values. Specifically, the nullify instructions can have the effect of cancelling a load or store instruction corresponding to a particular LSID or IID. For example, the nullify instruction can be targeted toward one or more load instructions identified by their LSIDs or IIDs. Thus, the nullify instruction can be a substitute for executing a load or store instruction with a particular LSID or IID. Additionally, the nullify instructions can have the effect of cancelling an instruction having a target corresponding to a particular RID. For example, the nullify instruction can be targeted toward one or more instructions identified by their RIDs or IIDs. Thus, the nullify instruction can be a substitute for executing an instruction targeting a particular RID.

As one example, the nullify instruction can be encoded using the format of the generic block instruction 520. The nullify instruction can be targeted toward an instruction that will not execute. When the non-executing instructions receive a null operand from the nullify instruction, control logic can be updated as though the non-executing instructions were executed. For example, instructions having alternative predicate values (alternative predicated instruction paths) can include instructions that write to registers 1 and 6 on one path (e.g., the true path) and an instruction that writes to register 8 on the other path (e.g., the false path). The true path can include a nullify instruction targeted to the instruction that writes to register 8 so that it appears to the control logic that all of the registers 1, 6, and 8 were written. The false path can include one or more nullify instructions targeted to the instructions that write to registers 1 and 6 so that it appears to the control logic that all of the registers 1, 6, and 8 were written. Thus, regardless of which predicate value is calculated and which instructions are executed, it can appear as though all of the registers were written.

As a specific example of a 32-bit nullify instruction, the opcode field can be encoded in bits [31:25]; the predicate field can be encoded in bits [24:23]; the broadcast identifier field can be encoded in bits [22:21]; a first target field can be encoded in bits [17:9]; and a second target field can be encoded in bits [8:0]. Depending on the ISA, the target fields can target an instruction having a particular IID, LSID, or RID. The bits [20:18] can be reserved for additional functions or for future use. As another example, a bulk-nullify instruction can use a mask to nullify a group of load-store or register write instructions in bulk using a bitmask to identify the nullified instructions. When nullifying load and store instructions, the bitmask can be encoded so that each bit of the bitmask corresponds to a different LSID. When an instruction block can include more LSIDs than can be supported by a single bitmask field of a bulk-nullify instruction, the bulk-nullify instruction can include a mask shift field that can be used to shift the bitmask over the full range of the LSIDs. For example a two-bit mask shift field and an eight-bit bitmask can be used to cover a range of 32 LSIDs. In particular, each instruction can nullify eight LSIDs and four different instructions can nullify all 32 LSIDs, where each instruction uses a different value in the mask shift field. When nullifying writes to the register file, the bitmask field can be encoded so that each bit of the bitmask corresponds to a different RID. As with the load-store bitmask, the register-write bitmask can be shifted to cover a range of RIDs that exceed the range of the bitmask. As a specific example of a 32-bit bulk-nullify instruction, the opcode field can be encoded in bits [31:25]; the predicate field can be encoded in bits [24:23]; the broadcast identifier field can be encoded in bits [22:21]; a register-write mask shift field can be encoded in bits [20:18]; and a register-write mask field can be encoded in bits [17:10]; a load-store mask shift field can be encoded in bits [9:8]; and a load-store mask field can be encoded in bits [7:0].

### VIII. Example States of a Processor Core

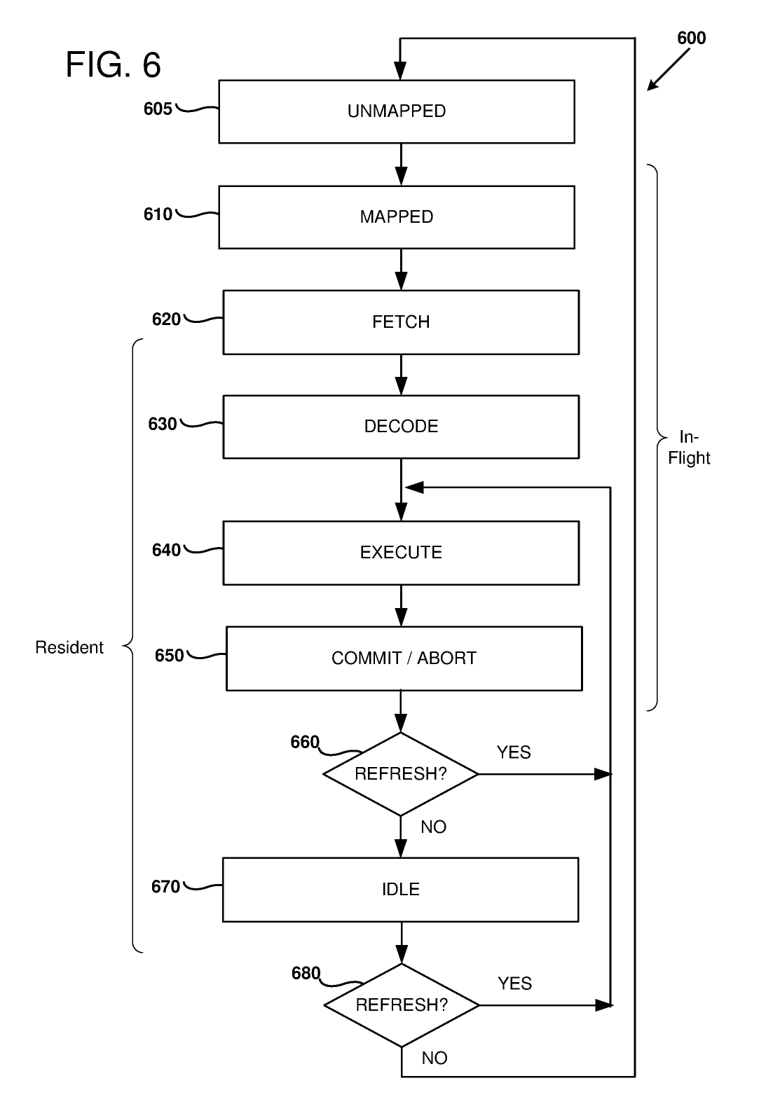

FIG. 6 is a flowchart illustrating an example of a progression of states 600 of a processor core of a block-based computer. The block-based computer is composed of multiple processor cores that are collectively used to run or execute a software program. The different processor cores can communicate by passing values through a global or inter-block register file and/or memory. The program can be written in a variety of high-level languages and then compiled for the block-based processor using a compiler that targets the block-based processor. The compiler can emit code that, when run or executed on the block-based processor, will perform the functionality specified by the high-level program. The compiled code can be stored in a computer-readable memory that can be accessed by the block-based processor. The compiled code can include a stream of instructions grouped into a series of instruction blocks. During execution, one or more of the instruction blocks can be executed by the block-based processor to perform the functionality of the program. Typically, the program will include more instruction blocks than can be executed on the cores at any one time. Thus, blocks of the program are mapped to respective cores, the cores perform the work specified by the blocks, and then the blocks on respective cores are replaced with different blocks until the program is complete. As one example, a single core can be used to execute all of the blocks of a program. Some of the instruction blocks may be executed more than once, such as during a loop or a subroutine of the program. An “instance” of an instruction block can be created for each time the instruction block will be executed. Thus, each repetition of an instruction block can use a different instance of the instruction block. As the program is run, the respective instruction blocks can be mapped to and executed on the processor cores based on architectural constraints, available hardware resources, and the dynamic flow of the program. During execution of the program, the respective processor cores can transition through a progression of states 600, so that one core can be in one state and another core can be in a different state.

At state 605, a state of a respective processor core can be unmapped. An unmapped processor core is a core that is not currently assigned to execute an instance of an instruction block. For example, the processor core can be unmapped before the program begins execution on the block-based computer. As another example, the processor core can be unmapped after the program begins executing but not all of the cores are being used. In particular, the instruction blocks of the program are executed, at least in part, according to the dynamic flow of the program. Some parts of the program may flow generally serially or sequentially, such as when a later instruction block depends on results from an earlier instruction block. Other parts of the program may have a more parallel flow, such as when multiple instruction blocks can execute at the same time without using the results of the other blocks executing in parallel. Fewer cores can be used to execute the program during more sequential streams of the program and more cores can be used to execute the program during more parallel streams of the program.

At state 610, the state of the respective processor core can be mapped. A mapped processor core is a core that is currently assigned to execute an instance of an instruction block. When the instruction block is mapped to a specific processor core, the instruction block is in-flight. An in-flight instruction block is a block that is targeted to a particular core of the block-based processor, and the block will be or is executing, either speculatively or non-speculatively, on the particular processor core. In particular, the in-flight instruction blocks correspond to the instruction blocks mapped to processor cores in states 610-650. A non-speculative block can be mapped when it is known during mapping of the block that the program will use the work provided by the executing instruction block. A speculative block can be mapped when it is not known during mapping whether the program will or will not use the work provided by the executing instruction block. Executing a block speculatively can potentially increase performance, such as when the speculative block is started earlier than if the block were to be started after or when it is known that the work of the block will be used. However, executing speculatively can potentially increase the energy used when executing the program, such as when the speculative work is not used by the program.

A block-based processor includes a finite number of homogeneous or heterogeneous processor cores. A typical program can include more instruction blocks than can fit onto the processor cores. Thus, the respective instruction blocks of a program will generally share the processor cores with the other instruction blocks of the program. In other words, a given core may execute the instructions of several different instruction blocks during the execution of a program. Having a finite number of processor cores also means that execution of the program may stall or be delayed when all of the processor cores are busy executing instruction blocks and no new cores are available for dispatch. When a processor core becomes available, an instance of an instruction block can be mapped to the processor core.

An instruction block scheduler can assign which instruction block will execute on which processor core and when the instruction block will be executed. The mapping can be based on a variety of factors, such as a target energy to be used for the execution, the number and configuration of the processor cores, the current and/or former usage of the processor cores, the dynamic flow of the program, whether speculative execution is enabled, a confidence level that a speculative block will be executed, and other factors. An instance of an instruction block can be mapped to a processor core that is currently available (such as when no instruction block is currently executing on it). In one embodiment, the instance of the instruction block can be mapped to a processor core that is currently busy (such as when the core is executing a different instance of an instruction block) and the later-mapped instance can begin when the earlier-mapped instance is complete. In one embodiment, the functionality of the instruction block scheduler can be distributed among the processor cores.

At state 620, the state of the respective processor core can be fetch. For example, the IF pipeline stage of the processor core can be active during the fetch state. Fetching an instruction block can include transferring instructions of the block from memory (such as the L1 cache, the L2 cache, or main memory) to the processor core, and reading instructions from local buffers of the processor core so that the instructions can be decoded. For example, the instructions of the instruction block can be loaded into an instruction cache, buffer, or registers of the processor core. Multiple instructions of the instruction block can be fetched in parallel (e.g., at the same time) during the same clock cycle. The fetch state can be multiple cycles long and can overlap with the decode (630) and execute (640) states when the processor core is pipelined.

When instructions of the instruction block are loaded onto the processor core, the instruction block is resident on the processor core. The instruction block is partially resident when some, but not all, instructions of the instruction block are loaded. The instruction block is fully resident when all instructions of the instruction block are loaded. The instruction block will be resident on the processor core until the processor core is reset or a different instruction block is fetched onto the processor core. In particular, an instruction block is resident in the processor core when the core is in states 620-670.

At state 630, the state of the respective processor core can be decode. For example, the DC pipeline stage of the processor core can be active during the decode state. During the decode state, instructions of the instruction block are being decoded so that they can be stored in the memory store of the instruction window of the processor core. In particular, the instructions can be transformed from relatively compact machine code, to a less compact representation that can be used to control hardware resources of the processor core. Predicated load and predicated store instructions can be identified during the decode state. The decode state can be multiple cycles long and can overlap with the fetch (620) and execute (640) states when the processor core is pipelined. After an instruction of the instruction block is decoded, it can be executed when all dependencies of the instruction are met.

At state 640, the state of the respective processor core can be execute. During the execute state, instructions of the instruction block are being executed. In particular, the EX and/or LS pipeline stages of the processor core can be active during the execute state. Data associated with load and/or store instructions can be fetched and/or pre-fetched during the execute state. Data can be read and/or written to the register file during the execute state. The individual instructions of the instruction block can executed out of program order. For example, scheduler logic or issue logic can issue each of the instructions to be executed in a dataflow order as the operands of the instructions become available. Issuing an instruction is initiating the execution of the instruction, such as by routing operands of the instruction to one or more registers, execution units, or a load-store queue.

The instruction block can execute speculatively or non-speculatively on the processor core. A non-speculative block is the oldest (in program order) non-committed instruction block being executed along a taken control path. For non-parallel (e.g., single-threaded) code, there can be only one non-speculative instruction block. For parallel (e.g., multi-threaded) code, there can be one non-speculative instruction block per thread. Work from a non-speculative block will be used if the non-speculative block is able to complete. A non-speculative block may fail to complete if there is an exception (such as a divide-by-zero or page-fault) with one of the instructions of the block, for example. When a non-speculative instruction block is terminated due to an exception, the processor can transition to the abort state.

A speculative block is a non-committed instruction block whose work may or may not be used by the program. For example, speculative blocks can be mapped and executed based on a predicted control flow of the program. If the control path containing the speculative block is mispredicted, the speculative block can be terminated (the work of the block can be abandoned) and the processor core can transition to the abort state. However, if the control path is correctly predicted, the speculative block can be converted to a non-speculative block when the preceding (in program order) instruction block transitions to the commit phase. Executing blocks speculatively may increase the speed of executing a program but may also use more energy than when only non-speculative execution is used.

An instruction block can complete when a variety of different conditions are met. For example, an instruction block can complete when it is determined that all register writes of the block are buffered, all writes to memory are buffered in a load-store queue, and a branch target is calculated. The execute state can be multiple cycles long and can overlap with the fetch (620) and decode (630) states when the processor core is pipelined. When the instruction block is complete and non-speculative, the processor can transition to the commit state. An instruction block can commit when it is determined that the instruction block is non-speculative (e.g., the work of the block will be used) and the instruction block is completed.

At state 650, the state of the respective processor core can be commit or abort. During commit, the work of the instructions of the instruction block can be atomically committed so that other blocks can use the work of the instructions. In particular, the commit state can include a commit phase where locally buffered architectural state is written to architectural state that is visible to or accessible by other processor cores. As one example, stores to memory can be buffered in a load-store queue during execution of the block, and the stores can be written to memory during the commit phase. When the visible architectural state is updated, a commit signal can be issued and the processor core can be released so that another instruction block can be executed on the processor core. Alternatively, the commit phase can overlap with execution of the next block and the load-store queue can be used to maintain a consistent view of memory. For example, memory consistency can be maintained by forwarding store data (buffered in the load-store queue) from a committed block to an executing block even while the stores from the committed block are still being written to memory.

During the abort state, any uncommitted state can be rolled back to a committed state. All or a portion of the pipeline of the core can be halted to reduce dynamic power dissipation. In some applications, the core can be power gated to reduce static power dissipation. Overlapping with or at the conclusion of the commit/abort states, the processor core can receive a new instruction block to be executed on the processor core, the core can be refreshed, the core can be idled, or the core can be reset.

At state 660, it can be determined if the instruction block resident on the processor core can be refreshed. As used herein, an instruction block refresh or a processor core refresh means enabling the processor core to re-execute one or more instruction blocks that are resident on the processor core. In one embodiment, refreshing a core can include resetting the active-ready state for one or more instruction blocks. It may be desirable to re-execute the instruction block on the same processor core when the instruction block is part of a loop or a repeated sub-routine or when a speculative block was terminated and is to be re-executed. The decision to refresh can be made by the processor core itself (contiguous reuse) or by outside of the processor core (non-contiguous reuse). For example, the decision to refresh can come from another processor core or a control core performing instruction block scheduling. There can be a potential energy savings when an instruction block is refreshed on a core that already executed the instruction as opposed to executing the instruction block on a different core. Energy is used to fetch and decode the instructions of the instruction block, but a refreshed block can save most of the energy used in the fetch and decode states by bypassing these states. In particular, a refreshed block can re-start at the execute state (640) because the instructions have already been fetched and decoded by the core. When a block is refreshed, the decoded instructions and the decoded ready state can be maintained while the active ready state is cleared. The decision to refresh an instruction block can occur as part of the commit operations or at a later time. If an instruction block is not refreshed, the processor core can be idled.

At state 670, the state of the respective processor core can be idle. The performance and power consumption of the block-based processor can potentially be adjusted or traded off based on the number of processor cores that are active at a given time. For example, performing speculative work on concurrently running cores may increase the speed of a computation but increase the power if the speculative misprediction rate is high. As another example, immediately allocating new instruction blocks to processors after committing or aborting an earlier executed instruction block may increase the number of processors executing concurrently, but may reduce the opportunity to reuse instruction blocks that were resident on the processor cores. Reuse may be increased when a cache or pool of idle processor cores is maintained. For example, when a processor core commits a commonly used instruction block, the processor core can be placed in the idle pool so that the core can be refreshed the next time that the same instruction block is to be executed. As described above, refreshing the processor core can save the time and energy used to fetch and decode the resident instruction block. The instruction blocks/processor cores to place in an idle cache can be determined based on a static analysis performed by the compiler or a dynamic analysis performed by the instruction block scheduler. For example, a compiler hint indicating potential reuse of the instruction block can be placed in the header of the block and the instruction block scheduler can use the hint to determine if the block will be idled or reallocated to a different instruction block after committing the instruction block. When idling, the processor core can be placed in a low-power state to reduce dynamic power consumption, for example.

At state 680, it can be determined if the instruction block resident on the idle processor core can be refreshed. If the core is to be refreshed, the block refresh signal can be asserted and the core can transition to the execute state (640). If the core is not going to be refreshed, the block reset signal can be asserted and the core can transition to the unmapped state (605). When the core is reset, the core can be put into a pool with other unmapped cores so that the instruction block scheduler can allocate a new instruction block to the core.

IX. Example Architectures including Transactional Register Files

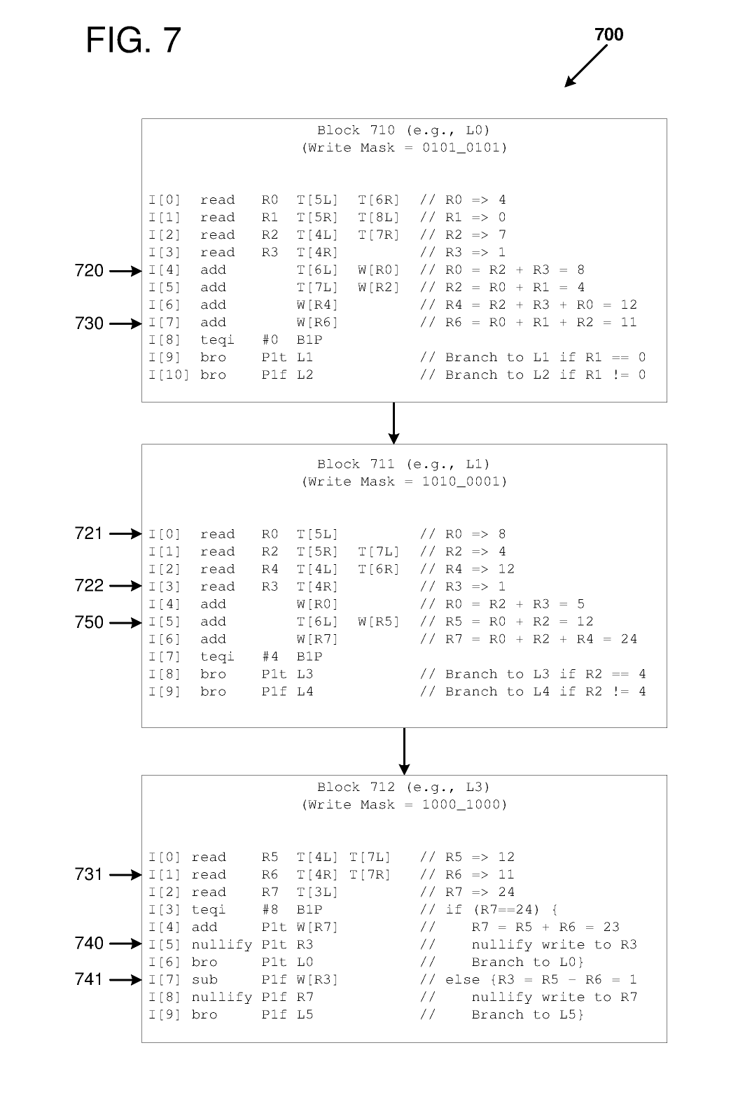

FIG. 7 illustrates an example snippet of instructions 700 of a program for a block-based processor. The program can include multiple blocks of instructions, such as instruction blocks 710-712. The program order of the instruction blocks 710-712 is determined dynamically at run-time based on processor state and control statements of the program. As illustrated, the block 710 is followed by block 711 which is followed by 712. An instruction block can include instructions that are to be executed as a group. For example, a given instruction block can include a single basic block, a portion of a basic block, or multiple basic blocks, so long as the instruction block can be executed within the constraints of the ISA and the hardware resources of the targeted computer. A basic block is a block of code where control can only enter the block at the first instruction of the block and control can only leave the block at the last instruction of the basic block. Thus, a basic block is a sequence of instructions that are executed together. Multiple basic blocks can be combined into a single instruction block using predicated instructions so that intra-instruction-block branches are converted to dataflow instructions.

An instruction block earlier in program order can communicate information to an instruction block later in program order by writing data to memory or to a global or transactional register file. For example, the register file can include multiple registers that can be accessed using an index or register identifier (RID). As a specific example, the register file can include 32 registers, and the registers can be accessed using the indices 0-31. The register having a particular index can be referred to as “R” concatenated with the index, such that the register at index 0 can be referred to as R0. Each of the instruction blocks 710-712 can include instructions for reading the registers and for writing the registers. In the illustrated ISA, the “read” instruction is the only instruction that reads from the global or inter-block register file; however any instruction can target (e.g., write) a register of the global register file. A write to register X of the register file is indicated by having a “W[RX]” in a target field of the instruction, where X is the index of the register. An earlier instruction can communicate a value to a later instruction block by writing to a particular register and the later instruction block can receive the value by reading the particular register. As a specific example, instruction 720 of the instruction block 710 can communicate a value to instruction 721 of the instruction block 711 using the register R0. The values can be communicated to later instruction blocks without using the instruction blocks in between the sender and the receiver. For example, instruction 730 of the instruction block 710 can communicate a value to instruction 731 of the instruction block 712 (skipping the instruction block 711) using the register R6. Example values from a sample run of the instruction blocks 710-712 are provided for illustrative purposes. As illustrated in FIG. 7, the expected data to be read from a register is presented after the “=>” symbol and the data to be written to a register is presented after the “=” symbol.

An EDGE ISA specifies each instruction block of a program is to be atomically executed so that all instructions within the instruction block are executed as a group. If the program is stopped or if the program services an interrupt, the stopping point will be at a block boundary and the visible architectural state at the stopping point will include only the updates from fully completed instruction blocks. Thus, updates to the visible architectural state due to a partial execution of an instruction block are not allowed under the atomic execution model of the EDGE ISA.

A microarchitecture specifies hardware resources and operations that are used to implement an ISA on a processor. One microarchitecture that can be used to implement the atomic execution model is a processor where the instruction blocks are serially executed so that one instruction block does not begin execution until the preceding instruction block is complete. In other words, only one instruction block can execute at a given time. In particular, the instructions of a given instruction block can be executed on a given processor core and the visible architectural state can be locally buffered and then updated in an atomic transaction. However, this type of microarchitecture may have reduced performance compared to a microarchitecture where multiple instruction blocks can be executing at the same time.

A potentially higher performing microarchitecture can include a processor having multiple processor cores, where the different processor cores can execute different instruction blocks concurrently. For example, a first processor core can be executing a non-speculative instruction block and the other cores can be executing speculative instruction blocks that are later in program order than the non-speculative instruction block. As a specific example, the instruction block 710 can be a non-speculative instruction block executing on a first processor core and the instruction blocks 711-712 can each be speculative instruction block executing on different processor cores of a processor. Generally, the instructions of the different instruction blocks can execute in parallel. However, some instructions in the different blocks may be sequenced so that any dependencies among the instructions are satisfied. For example, dependencies between blocks can occur when the blocks communicate using the visible architectural state. An instruction later in program order can be delayed until a value satisfying the dependency is generated. As a specific example, an instruction reading a register that is written by an instruction in an earlier instruction block can be delayed until the register is written. The dependencies can be tracked by the resources of the microarchitecture so that the instructions are issued in correct program order. The ISA can constrain access patterns of the visible architectural state to simplify the microarchitecture. In one embodiment, a given register of the register file can only be written once during an instruction block and all reads of the given register return the value stored before execution of the instruction block. Thus, the register of the register file are used only for communicating values between instruction blocks and not between instructions within a single instruction block.

Reads and writes to a given register can create data dependencies such as read-after-write (RAW), write-after-read (WAR), and write-after-write (WAW) dependencies. For the read-after-write dependency, a value written to a register in an earlier instruction block should be retrieved by a read instruction in a later instruction block when there are no intervening writes to the register. For the write-after-read dependency, a register read instruction occurring in an earlier instruction block than an instruction writing to the same register in a later instruction block should return the value stored at the register before the register is updated with the value from the later write. For the write-after-write dependency, data written to a register by a first instruction in an earlier instruction block should be overwritten by data written to the same register by a second store instruction in a later instruction block. In one embodiment, reads within an instruction block use values generated only by earlier instruction blocks so that there is no dependency between a read and a write to the same register within an instruction block. As a specific example, for a block including a read instruction of register RX and an instruction which targets RX with a new, different value, the instruction reading RX will always obtain its original value of RX (the value of RX generated by an earlier block) irrespective of the order that the two instructions appear in memory or of the order that the two instructions execute during the execution of the block.

The microarchitecture can enable multiple instruction blocks of a single thread to be executing concurrently while tracking dependencies between the different instruction blocks. For example, the instruction block 710 can be a non-speculative instruction block executing on a first processor core and the instruction blocks 711-712 can each be speculative instruction blocks executing on different processor cores, and all of the instruction blocks can be executing concurrently. The visible architectural state (e.g., the memory and the register file) can be used to pass values from an earlier instruction block to a later instruction block. Specifically, the instruction block 710 can pass values to the instruction block 711 using the registers R0, R2, and R4; the instruction block 710 can pass a value to the instruction block 712 using the register R6; and the instruction block 711 can pass values to the instruction block 712 using the registers R5 and R7. Rather than waiting for the non-speculative block to complete and be committed, hardware resources can be used to forward early non-committed values of the visible architectural state to later-executing speculative instruction blocks. If an instruction block is aborted due to mispeculation or due to an exception, the non-committed values can be rolled back so that the visible architectural state contains only the values according to the atomic execution model.

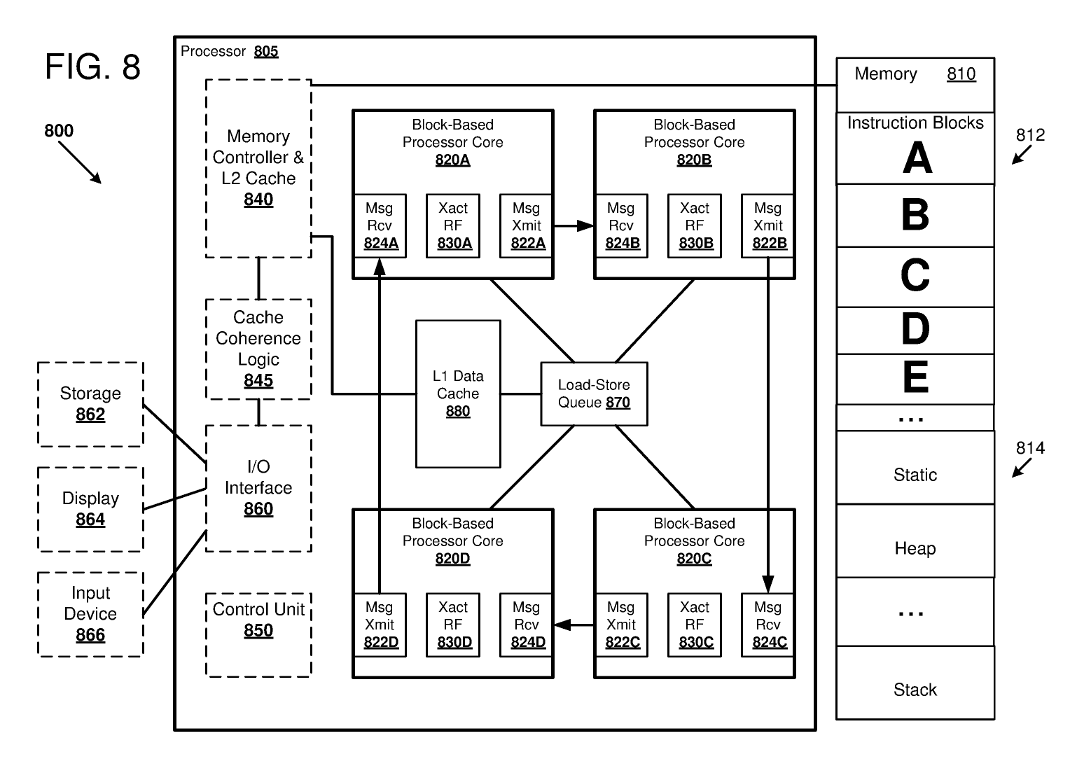

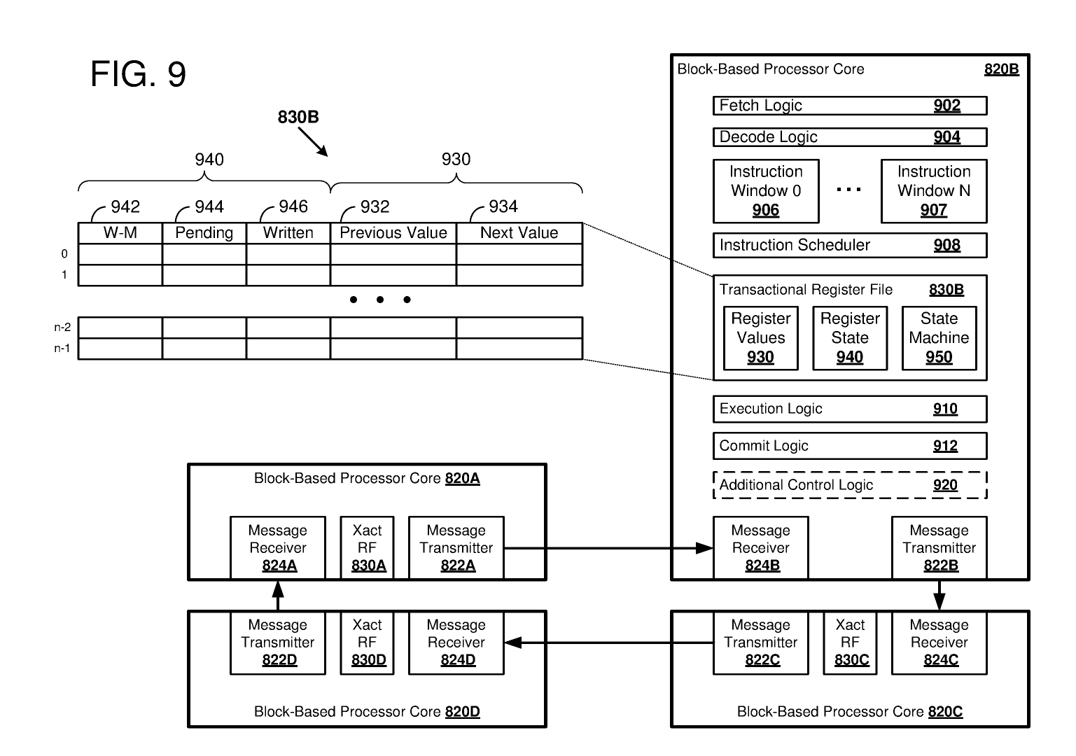

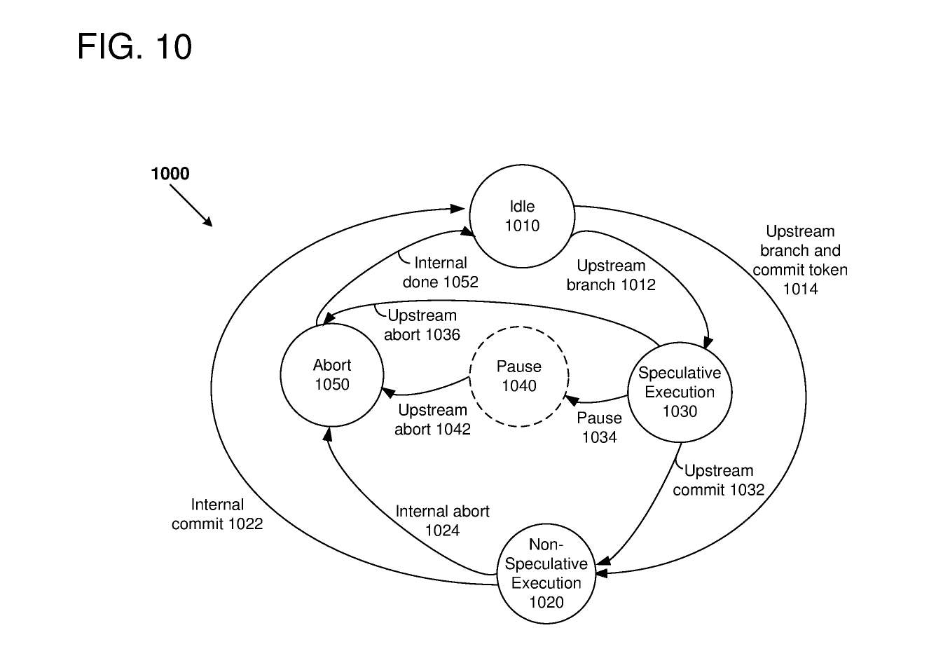

FIGS. 8-10 illustrate various aspects of an example computing system including multiple processor cores and a transactional register file for executing instruction blocks of a program. In particular, FIG. 8 illustrates an example computing system 800 including multiple block-based processor cores 820A-D having transactional register files 830A-D. FIG. 9 illustrates additional details of the block-based processor cores 820A-D and the transactional register files 830A-D. FIG. 10 illustrates an example state diagram of the block-based processor cores 820A-D.

FIG. 8 illustrates an example computing system 800 including multiple block-based processor cores 820A-D. The computing system 800 can be used for executing a program on the block-based processor cores. For example, the program can include the instruction blocks A-E (or the instruction blocks 710-712 from FIG. 7). The instruction blocks A-E can be stored in a memory 810 that can be accessed by the processor 805. The processor 805 can include a plurality of block-based processor cores (including block-based processor cores 820A-D), an optional memory controller and level-two (L2) cache 840, cache coherence logic 845, a control unit 850, an input/output (I/O) interface 860, and a load-store queue 870. It should be noted that for ease of illustration, not every connection between every component of the processor 805 is shown. Additional connections between the components are possible (e.g., the control unit 850 can communicate with all of the processor cores 820A-D). It should also be noted that while four processor cores are shown, more or fewer processor cores are possible. The block-based processor core 820 can communicate with a memory hierarchy or memory sub-system used for storing and retrieving instructions and data of the program.

The memory hierarchy can be used to potentially increase the speed of accessing data stored in the main or system memory 810. Generally, a memory hierarchy includes multiple levels of memory having different speeds and sizes. Levels within or closer to the processor core are generally faster and smaller than levels farther from the processor core. For example, a memory hierarchy can include a level-one (L1) cache within a processor core, a level-two (L2) cache within a processor that is shared by multiple processor cores, main or system memory that is off-chip or external to the processor, and backing store that is located on a storage device, such as a hard-disk drive. When the memory hierarchy is accessed, the faster and closer levels of the memory hierarchy can be accessed before the slower and farther levels of the memory hierarchy. As one example, the memory hierarchy can include the level-one (L1) cache 828, the memory controller and level-two (L2) cache 840, and the memory 810. The memory controller and the level-two (L2) cache 840 can be used to generate the control signals for communicating with the memory 810 and to provide temporary storage for information coming from or going to the memory 810. As illustrated in FIG. 8, the memory 810 is off-chip or external to the processor 805. However, the memory 810 can be fully or partially integrated within the processor 805.

The control unit 850 can be used for implementing all or a portion of a run-time environment for the program. The runtime environment can be used for managing the usage of the block-based processor cores and the memory 810. For example, the memory 810 can be partitioned into a code segment 812 comprising the instruction blocks A-E and a data segment 815 comprising a static section, a heap section, and a stack section. As another example, the control unit 850 can be used for allocating processor cores to execute instruction blocks, and assigning a block identifier to each of the instruction blocks. The optional I/O interface 860 can be used for connecting the processor 805 to various input devices (such as an input device 866), various output devices (such as a display 864), and a storage device 862. In some examples, the components of the processor core 820, the memory controller and L2 cache 840, the cache coherence logic 845, the control unit 850, the I/O interface 860, and the load-store queue 870 are implemented at least in part using one or more of: hardwired finite state machines, programmable microcode, programmable gate arrays, or other suitable control circuits. In some examples, the cache coherence logic 845, the control unit 850, and the I/O interface 860 are implemented at least in part using an external computer (e.g., an off-chip processor executing control code and communicating with the processor 805 via a communications interface (not shown)).

All or part of the program can be executed on the processor 805. Specifically, the control unit 850 can allocate one or more block-based processor cores, such as the processor cores 820A-D, to execute the program. It should be noted that when explaining common aspects of the processor cores 820A-D, the cores may be referred to as the processor core 820. The control unit 850 and/or one of the processor cores 820A-D can communicate a starting address of an instruction block to each processor core 820 so that the instruction block can be fetched from the code segment 812 of the memory 810. Specifically, the processor core 820 can issue a read request to the memory controller and L2 cache 840 for the block of memory containing the instruction block. The memory controller and L2 cache 840 can return the instruction block to the processor core 820. The control unit 850 can communicate a block identifier of the instruction block allocated to each processor core 820 so that a program order of the instruction blocks can be identified. The control unit 850 can also designate the instruction blocks as non-speculative or speculative. Additionally or alternatively, the logic for selecting the next instruction block and determining whether an instruction block is speculative or non-speculative can be distributed among the processor cores 820A-D.

The visible architectural state includes the memory (e.g., the memory hierarchy) and the registers of the global register file. The microarchitecture of the processor 805 can include hardware resources for maintaining the visible architectural state and providing speculative copies of the visible architectural state to the processor cores 820. In particular, the processor 805 can include a load-store queue 870 for buffering speculative and non-speculative in-flight load and store instructions to the memory hierarchy and for enforcing sequential memory semantics. Specifically, the load-store queue 870 can detect potential dependencies between the load and store instructions and can sequence the instructions in partial or full program order so that any dependencies between the instructions are satisfied. The data for the store instructions can be buffered in the load-store queue 870 which can interface with the memory hierarchy to drain the store data to memory after the store instructions are committed. Load response data can be generated in the load-store queue 870 using the buffered data from the store instructions and/or data retrieved from the memory hierarchy. In this manner, the load-store queue 870 can be used to maintain the memory following the atomic block execution model of the ISA while providing speculative memory values to the processor cores 820A-D so that the processor cores 820A-D can potentially execute more instructions in parallel.

The processor cores 820A-D can include a distributed transactional register file (Xact RF) 830A-D for maintaining the visible architectural state corresponding to the registers. Specifically, the transactional register file 830 can store the committed register values that are visible to a programmer and uncommitted speculative register values that can be used by speculative instruction blocks to potentially increase the speed of computation. The transactional register file 830 can be updated using an inter-core communication system between the processor cores 820A-D. The communication system can be incorporated within the transactional register file 830 or can be in communication with the transactional register file 830.

As one example, the communication system can include message transmitters (Msg Xmit) 822A-D and message receivers (Msg Rcv) 824A-D. As illustrated, the message transmitters 822A-D and the message receivers 824A-D can be connected so that the cores 820A-D form a generally unidirectional ring and messages can be sent over the ring. The messages can generally flow in one direction over the ring, however, in some embodiments a back-pressure signal or other types of messages may flow in a direction opposite of the main flow. In other embodiments, the cores 820A-D can be connected in other arrangements. Messages can be passed from one processor core to another processor core. The messages can be consumed by the receiving core and/or transmitted (modified or unmodified) to the next downstream processor core. A core executing an instruction block earlier in program order is referred to as being upstream of a core that is executing an instruction block later in program order. As a specific example, a message can be sent from the core 820A downstream to the core 820B which can forward the message to the core 820C which can forward the message to the core 820D which can forward the message to the core 820A. Thus, a core sending a message can receive the message that it sent. The messages can include a core identifier to indicate a source of the message so that a source core can terminate a message that has travelled around the ring and is returning to the source core.

In a fused execution mode, the processor cores 820A-D can be used to execute the instruction blocks of a thread. Within the thread, the instruction blocks have a program order, where one instruction block can be non-speculative and instruction blocks later in program order can be speculative. As a specific example, at a given point in time, the core 820A can be executing the non-speculative instruction block, the downstream cores 820B-C can be executing speculative instruction blocks later in program order, and the core 820D can be idle where no instruction block has been assigned to it yet. The later instruction blocks can depend on calculations from the earlier instruction blocks. The earlier or upstream instruction blocks can send results and other information to the later or downstream instruction blocks by sending messages using the communication system. As a specific example, the core 820A can send a message downstream to the core 820B by transmitting a message using the transmitter 822A and the core 820B can receive the message using the receiver 824B.

The transactional register file 830 can perform a variety of functions. For example, the transactional register file 830 can store both committed and uncommitted (e.g., speculative) values of the registers. By storing the committed values, the visible architectural state can be maintained according to an atomic execution model. By storing the uncommitted values, the processor cores 820A-D can perform work earlier than if each instruction block must be committed before the next instruction block can begin. Specifically, earlier (in program order) calculated values of registers can be forwarded to instruction blocks occurring later in program order. The transactional register file 830 can track dependencies between the instruction blocks (such as by using a register write mask) and can cause execution of the dependent instructions to be delayed until the dependencies are satisfied. When an instruction block aborts due to being mispeculated or due to an exception occurring within the block, the transactional register file 830 can be used to roll-back any speculative values stored for the registers so that only committed values are architecturally visible.

In a non-fused or multi-threaded execution mode, each of the processor cores 820A-D can be used to execute a different thread. For example, the message transmitter of a processor core can be routed, such as by using configurable logic (not shown), back to the message receiver of the same processor core. As a specific example, the processor core 820A can be configured in a non-fused mode by connecting the message transmitter 822A to the message receiver 824A. Thus, the values of the transactional register file 830A can be localized to the processor core 820A when the processor core 820A is configured in the non-fused execution mode. Thus, the processor 805 may be configured to run four threads on the four cores 820A-D (using the non-fused execution mode), or run one thread with speculative block execution across the four cores 820A-D (using the fused execution mode). Additionally or alternatively, the communication paths between the message transmitters and receivers can be re-routed (such as by using programmable multiplexed communication paths) so that different numbers and combinations of cores can be fused. As a specific example, the path from transmitter 822B can be re-routed to receiver 824A and the path from transmitter 822D can be routed to receiver 824C so that two threads can be executed on the processor pairs 820A-B and 820C-D. Different numbers of cores and routing arrangements can be used to create different combinations of fused and non-fused configurations.

The different processor cores 820A-D can send messages between each other to communicate register values and control information. Table 1 provides an example set of messages that can be sent between the processor cores 820A-D and actions that can be associated with receiving each of the messages:

| Example Message | Example Action taken by a Receiving Core |
|---|---|
| Branch | Fetch an instruction block at the branch address |
| Commit/Non- | Make the executing block non-speculative |
| speculative token | |
| Write-Mask | Delay issuing instructions dependent on these registers |
| Register-Write | Update specified register with a new register value |
| Abort | Roll-back any uncommitted register writes |
| Pause | Delay issuing instructions |

FIG. 9 illustrates additional aspects of an example processor including multiple processor cores 820A-D and a transactional register file 830A-D for executing instruction blocks of a program. For example, FIG. 9 is used to illustrate an example of how the different processor cores 820A-D can communicate with each other and how the transactional register file 830A-D can be used to support an atomic execution model. In this example, the processor cores 820A-D are homogeneous, but in other examples, the processor cores 820A-D can be heterogeneous with various common components. It should be noted that for ease of illustration, the alphabetic subscript is generally omitted in the following description unless the subscript can provide additional clarity (e.g., core 820A can be referred to as core 820, and so forth).

An instruction block can be fetched, decoded, and executed on the processor core 820 in response to receiving a “branch” message by the message receiver 824. The branch message can include an address of an instruction block to fetch. The fetch logic 902 can be used to fetch the instruction block from memory at the address provided by the branch message. The fetched instruction block can include an instruction header and instructions. The individual instructions can be decoded by the decode logic 904 and information from the decoded instructions can be stored in one or more instruction windows 906-907. The instruction header can be decoded by the decode logic 904 to determine information about the instruction block, such as a store mask and/or a write mask of the instruction block. The store mask can identify the store instructions of the instruction block and the write mask can identify which registers are written by the instruction block. The store mask and the write mask can be used in combination with other information to determine if dependencies of some instructions are satisfied so that those instructions can be issued by the instruction scheduler 908. During execution, the instructions of the instruction block are issued or scheduled dynamically for execution by the instruction scheduler 908, based on when the instruction operands become available. Thus, the issued or execution order of the instructions can be different from the program order of the instructions. The instructions can be fully or partially executed using execution logic 910 (such as arithmetic logic units).

The results of the executed instructions can target other instructions, memory, or registers of the transactional register file 830. When the instructions target other instructions, the results of the instructions can be written back to operand buffers of the instruction windows 906-907. When the instructions target memory, the results of the instructions can be written to a load-store queue (such as the load-store queue 870 of FIG. 8). When the instructions target registers, the results of the instructions can be written to the transactional register file 830. The load-store queue provides intermediate buffering for the results of the store instructions and the transactional register file 830 provides intermediate buffering for the results of the instructions being written to registers. The intermediate results are not fully released (made architecturally visible) until the executing instruction block is non-speculative and commits.

The commit logic 912 can monitor the commit conditions of the instruction block and can commit the instruction block when the conditions are satisfied. For example, the commit conditions can include completing all store instructions and all writes to the transactional register file 830, calculating a branch address to the next instruction block, and the instruction block being non-speculative. The commit logic 912 can determine that all store instructions have issued by comparing the decoded store mask to a list or vector of issued store instructions of the instruction block. The commit logic 912 can determine that all writes to the registers have occurred by comparing the decoded write mask to a list or vector of register writes that have occurred during execution of the instruction block. The commit logic 912 can determine that the branch address has been calculated when a branch instruction of the instruction block is executed. The commit logic 912 can determine that the instruction block is non-speculative when the message receiver 824 receives a “commit” message or a commit token. Receiving the commit token indicates that the instruction block preceding the current instruction block was non-speculative and was committed, so the currently executing instruction block is now the non-speculative instruction block. The commit message can be received concurrently with receiving the branch message or at a different time.

When the commit conditions are satisfied, the visible architectural state can be updated in an atomic transaction. For example, the store entries in the load-store queue can be marked as committed, and the store data can begin to be written back to the memory hierarchy. As another example, and as described further below, the committed values of the registers of the transactional register file 830 can be updated. The commit logic 912 can also cause the message transmitter 822 to send a “commit” message to a downstream processor core.

The processor core 820 can include additional control logic 920, such as branch prediction logic for predicting a branch address of a later instruction block, power control logic for powering all or a portion of the processor core 820 up or down, and abort management logic for cleaning up mispeculated state. As a specific example, the additional control logic 920 can include branch prediction logic that can predict a branch address of a later instruction block while the instruction block is still executing and before the commit conditions are satisfied. The branch prediction logic can cause a branch message to be sent to a downstream processor core so that the processor core can begin speculative execution of the predicted instruction block before the currently executing instruction block is committed. Thus, multiple instruction blocks can be executed in parallel which can potentially increase the performance of the processor.

The transactional register file 830 can be used to maintain the atomically committed register values and to provide early speculative versions of the registers to the speculative instruction blocks. The values stored in the transactional register files 830A-D can be distributed across all of the processor cores 820A-D. The committed register values can be stored in the transactional register file corresponding to the non-speculative instruction block, and these values can be transmitted to the transactional register files on the other processor cores. Speculative register values can be stored in one or more of the individual transactional register files 830A-D. Speculative register value updates are committed when the instruction block commits Speculative register value updates are discarded when the instruction block aborts. Causes of a block abort may include branch mispeculation, a floating point exception, or other events occurring in the block or in prior blocks.

The transactional register file 830 can include a plurality of entries corresponding to individually addressable registers. For example, an n-entry transactional register file 830 can include n different entries (labelled 0-(n-1) in FIG. 9) corresponding to the n different registers. The transactional register file 830 can be implemented using a RAM and/or flip-flops or latches for storing the information in the transactional register file 830. Each entry of the transactional register file 830 can include various different fields for storing register values 930 and register state 940 for the register corresponding to the entry. Specifically, the register values 930 can include fields for storing a previous value 932 and a next value 934. The previous value 932 can be used to store a value calculated by an earlier instruction block and the next value 934 can be used to store a value calculated by a later instruction block. Thus, each entry of the transactional register file 830 can store multiple values and states associated with a given register.

The register state 940 can be used to track registers from earlier blocks that have not been written yet, registers that may be written by the instruction block executing on this core, and registers that have been written by this core. As one example, the register state 940 can include fields for storing a write-mask (W-M) state 942, a pending state 944, and a written state 946. The write-mask state 942 can be used to track all of the register writes that may be executed by the instruction block executing on the processor core. For example, the write-mask state 942 can be a copy of the write mask that is decoded from the instruction header of the instruction block. The pending state 944 can be used to track registers from earlier blocks that may be written but have not been written yet and which may create dependencies within the instruction block. The written state 946 can be used to track the registers that have been written by the core.

The transactional register file 830 can include a state machine 950. The current state of the state machine 950 in combination with the register state 940 can be used to determine which register values within the transactional register file 830 are the committed values and which register values are speculative values. As one example, the state machine 950 can include a non-speculative state indicating that instruction block executing on the core is executing non-speculatively. When the state machine 950 is in the non-speculative state, the previous value 932 can hold the committed values of the registers. Other states of the state machine can include a speculative state, an idle state, an abort state, and a pause state. The state machine 950 is discussed in more detail further below with respect to FIG. 10. The states of the state machine 950 can be used to determine how the transactional register file 830 is updated when messages are received on the communication system and other actions to perform based on the messages.

A “write-mask” message can be received and decoded by the message receiver 824. The write-mask message can indicate all of the registers that may be written by the instructions of earlier non-committed instruction blocks. For example, an instruction header of each instruction block can include a write mask field indicating all of the registers that may be written by the instructions of the instruction block. Instruction blocks that follow the executing instruction block can be dependent on the writes to the registers. A non-speculative instruction block can send a write-mask message to a downstream processor core. The core receiving the write-mask message can mark the registers specified in the message as pending by asserting (e.g., assigning or setting a value of one) the pending state 944 for each specified register. When the register is pending from an earlier instruction block, any instructions that read the pending register can be delayed until after the register is updated. As a specific example from FIG. 7, the lower eight bits of the write mask from block 710 are “0101_0101,” indicating that the registers R0, R2, R4, and R6 will be written. The write mask for the executing instruction block can be written to the write-mask state 942. In this example, the block 710 can be non-speculatively executing on the core 820A. The core 820A can use the transmitter 822A to send a write-mask message to the receiver 824B on the core 820B. The write-mask message can include the write mask from the block 710, and the pending state 944 can be updated with the received write mask values. Specifically, the lower eight bits of the pending state 944 can be updated with “0101_0101.”

The pending state 944 can be communicated to the instruction scheduler 908. The instruction scheduler 908 can delay instructions that read registers that have not been written yet, as indicated by the pending state 944. As a specific example from FIG. 7, the core 820B can be speculatively executing the instruction block 711. Register R0 is written in the block 710 by the instruction 720 and read in the block 711 by the instruction 721. The instruction scheduler 908 can delay the instruction 721 until the dependencies of the instruction 721 are satisfied (e.g., until after the instruction 720 has written to the register R0). In contrast, register R3 is not written by the block 710. When block 710 is the non-speculative block, the register R3 will have been committed in an earlier block. The bit of the pending state 944 corresponding to the register R3 (bit 3) is not asserted and so the instruction scheduler 908 can issue the instruction 722 as soon as hardware resources are available to execute the instruction.

A composite write-mask message can be forwarded by a speculative or idle core. For example, later instruction blocks can depend on register writes from all earlier non-committed instruction blocks. Thus, a write-mask message can be forwarded with information for all non-committed blocks. As a specific example from FIG. 7, the core 820B can be speculatively executing the instruction block 711. A write-mask message can be generated that combines the pending state 944 and the write mask information from the block 711. The lower eight bits of the write mask from the block 711 are “1010_0001,” indicating that the registers R0, R5, and R7 will be written by the block 711. The write-mask message can perform a bit-wise-or function on the pending state 944 and the write-mask state 942 to generate the composite write-mask of “1111_0101” indicating all of the registers that may be written by the blocks 710 and 711. The composite write-mask can be transmitted by the transmitter 822B to the receiver 824C on the core 820C.

A “register-write” message can be generated and the written state 946 can be updated in response to an instruction being executed and writing to a register. In particular, the instruction scheduler 908 can issue a decoded instruction to the execution logic 910, where the decoded instruction specifies a register to write a result from the execution logic 910. The execution logic 910 can cause the written state 946 corresponding to the register being written to be asserted, indicating that the register has been written. The execution logic 910 can cause the register-write message to be transmitted by the transmitter 822 and received and decoded by the message receiver 824. As a specific example from FIG. 7, the core 820A can be executing the instruction block 710 and the instruction 720 can be executed. The results from instruction 720 are targeted to the register R0. In response to the instruction 720 being executed, bit 0 of the written state 946 can be asserted (e.g., set to a 1) in core 820A and a register-write message can be sent from transmitter 822A and received by receiver 824B. The register-write message can indicate the register that was written (e.g., R0) and the value that was written (e.g., 8).

A speculative or idle core receiving the register-write message can update the previous register value 932 and can deassert (e.g., clear, negate, or zero) the pending register state 944 corresponding to the register that was written. Continuing with the example from FIG. 7, the core 820B can receive the register-write message corresponding to the register R0 being written in the core 820A by the instruction 720. Within the core 820B, the previous register value 932 for register R0 can be written with an 8 and the pending register state 944 for register R0 can be deasserted (e.g., cleared to a 0), indicating that the register R0 has been written by an earlier instruction block.

A speculative or idle core receiving the register-write message can selectively forward the register-write message to a downstream core based on whether the register is written in the receiving core. If the register will not be written in the receiving core (e.g., the bit in the write-mask state 942 corresponding to the register is deasserted), the register-write message can be forwarded to the downstream core. However, if the register will be written in the receiving core (e.g., the bit in the write-mask state 942 corresponding to the register is asserted), the register-write message will not be forwarded to the downstream core. Continuing with the example from FIG. 7, the register R0 is written in both of the instruction blocks 710 and 711. Thus, when the register-write message sent in response to the instruction 720 is received in core 820B, the register-write message will not be forwarded to the core 820C. However, the register R6 is written only in the block 710. When the instruction 730 executes, bit 6 of the written state 946 is asserted in core 820A and a write-message indicating that register R6 was written with the value 11 can be transmitted from the transmitter 822A to the receiver 824B on core 820B. The instruction block 711 executing on the core 820B does not write to the register R6 (e.g., bit 6 of the write-mask state 942 is deasserted) so the register-write message can be forwarded by the transmitter 822B to the receiver 824C on the core 820C. The previous value 932 corresponding to register R6 can be updated with the value 11 in both the cores 820B and 820C.

A non-speculative core receiving the register-write message can update the next register value 934 corresponding to the register that was written. The register-write message can originate in the non-speculative core (e.g., it can be caused by an instruction executing on the non-speculative core) and can be forwarded by the downstream cores back to the originating core. When the message is received by the originating core, the next register value 934 is updated rather than the previous register value 932. Additionally, a register-write message can originate in a speculative core (e.g., it can be caused by an instruction executing on the speculative core) and can be forwarded by the downstream cores back to the non-speculative core. When the message is received by the non-speculative core, the next register value 934 is updated rather than the previous register value 932. Continuing with the example from FIG. 7, the core 820A is the only core to write the register R6 (using the instruction 730). When the instruction 730 is executed, a register-write message will be originated in the core 820A and the register-write message will be forwarded by the downstream cores (820B, 820C, and 820D) back to the originating core (820A). When the register-write message is received by the core 820A, the next register value 934 for register R6 can be written with an 11. Instruction 750 of block 711 is the only instruction to write to register R5 from the blocks 710-712. When the instruction 750 is executed, a register-write message for register R5 is generated and transmitted from the core 820B to the core 820C to the core 820D to the non-speculative core 820A. When the register-write message is received by the core 820A, the next register value 934 for register R5 can be written with a 12. In one embodiment, the register-write message can be forwarded from the core 820A to the core 820B and the next register value 934 for register R5 can be written with a 12 on core 820B also.

The write mask can indicate that more registers will be written than are actually written by the instruction block. For example, the write mask can include registers that are written to by predicated instructions. Depending on the predicate value that is calculated during execution of the instruction block, the registers may or may not be written. A nullify instruction can be added to account for register writes that are not executed. For example, a first predicated instruction can write to a first register when a first predicate value (e.g., a true value) is calculated. If the first register is not written when a different predicate value (e.g., a false value) is calculated, the write to the first register can be cancelled using a nullify instruction.

A nullify instruction can cause a register write message to be generated and transmitted to a downstream core. In particular, the register write message can indicate the register that was not written, and the value of the register from previous instruction blocks (e.g., the previous value 932). As a specific example from FIG. 7, the instruction 740 can be used to nullify a write to register R3 when the predicate value is true. The nullify instruction is used to cancel the write to register R3 that would be executed if the predicate value was false and the instruction 741 were executed. As illustrated, execution of the nullify instruction 740 will cause a register write message to be generated indicating that register R3 has a value of 1 (the value stored in the previous value 932).

The non-speculative core can complete successfully and commit or the non-speculative core can abort due to an exception. A non-speculative core receiving the register-write message can update the next register value 934 corresponding to the register that was written. Thus, the non-speculative core can have committed values in the previous value register 932 and speculative values in the next register value 934. If the non-speculative core successfully completes and commits, the core 820 can copy each next register value 934 into each corresponding previous value register 932 so that the previous value register 932 will contain speculative register values. The committed register values will be stored in the previous value register 932 of the downstream core that will be the new non-speculative core. The committing core can send the commit message to the downstream core so that the downstream core can transition to being the non-speculative core. The committing core can transition to an idle state when the commit message is sent. However, if the non-speculative core detects an exception (such as when the execution logic 910 detects an exception), the core can transition to the abort state and any speculatively written registers can be reverted to committed values.

In some embodiments, such as when the register values 930 reside in discrete registers or flip-flops, the copying of each next value 934 to each previous value 932 can be accomplished in one cycle. In some embodiments, such as when the register values 930 reside in one or more RAMs, the copying of each next value 934 to each previous value 932 can be iterative over several clock cycles, for example, one cycle for each register. In some embodiments, only those register values which were written or otherwise updated since the last commit in this core 820 will be copied. In some embodiments, rather than previous 932 and next 934 arrays, there are two register files “copy0” and “copy1” implemented in two n-entry RAMs, and there are two vectors of n-flip-flops (i.e. two n-bit registers), herein called PREV[] and NEXT[] that determine, on an entry-by-entry basis, for register #X, which of copy0[X] or copy1[X] contains the corresponding previous or next value. That is, the ‘prey’ value for register #X is obtained as ‘if (PREV[X]==0) then copy0[X] else copy1[X]’ and ‘next’ value for register #X is ‘if (NEXT[X] ==0) then copy0[X] else copy1[X]’. Then to commit a block, the register NEXT[] can be copied into the register PREV[]; to initialize or abort a block, the register PREV[] can be copied into register NEXT[], and to write a next register #X value, first set NEXT[X] to not(PREV[X]). By using this arrangement of two value arrays and two registers, the arrangement can enable register file contents to be kept in RAM arrays while potentially achieving single-cycle commit and single-cycle abort of a transactional register file by simply copying one vector of flip-flops to another. In some embodiments, the arrays previous 932 and next 934 or the arrays copy0[] and copy1[] are implemented using FPGA LUT RAM or FPGA block RAM memories.

The aborting core can send a “pause” message to the downstream cores so that the downstream cores can stop issuing speculative instructions that will not be used. By stopping instructions from being issued, fewer speculative changes to the registers and/or memory may be performed which can potentially allow the processor to recover more quickly from an abort condition and can increase performance of the processor. The core receiving the pause message can enter a low-power mode which can gate clocks or perform other actions which can reduce the power of the core so that the energy consumption of the core can be reduced.

The aborting core can send a register-write message for each of the registers that was written by the core. For example, the aborting core can determine all of the registers that were written by analyzing the written state 946. The written state 946 will include an asserted bit for each of the registers that was written by the core, which is a subset of the registers identified by the write mask. The aborting core can retrieve the last committed value for each register from the previous register value 932 and can send a register-write message downstream with the value from the previous register value 932. Thus, all of the previous register values 932 in the downstream cores can be updated with the last committed values of the registers.

The aborting core can send an “abort” message to the downstream core so that the downstream core can revert any speculatively written registers back to committed values. In particular, the aborting core can send the abort message to the downstream core after all of the register-write messages corresponding to the speculatively written registers have been sent. The aborting core can transition to the idle state when the abort message is sent. Additionally, a committing non-speculative core can detect that the downstream core was mispredicted and can send an abort message to the downstream core. In particular, a branch address generated by the branch predictor (and transmitted in a branch message) can be compared to the branch address generated by the execution logic 910. If the calculated branch addresses differ, the committing core can send the abort message to the downstream core.

The core receiving the abort message can transition to the abort state and can begin to revert any speculatively written registers back to committed values. If the core had not written any registers yet (e.g., there are no asserted bits in the register written state 946), the core can forward the abort message to the next downstream core and transition to the idle state. If an idle core receives the abort message, the idle core can generate a completed abort signal that can be used by the control unit or one of the processor cores to restart execution of the program. Thus, an abort message in an upstream core can cause a cascade of abort messages in downstream cores, where each downstream core can roll back any speculative updates before sending an abort message to its downstream core.

As a specific example from FIG. 7, blocks 710-712 can be executing on cores 820A-C, respectively, and core 820D can be idle. In this example, the core 820A is executing non-speculatively and the cores 820B-C are executing speculatively. The core 820A detects an abort condition after the core 820A has sent register writes for registers R0 and R2, the core 820B has sent register write for register R5, and the core 820C has not sent any register writes. When the abort is detected, the core 820A can send a pause message downstream to the core 820B which sends a pause message to the core 820C which sends a pause message to the core 820D so that no more speculative register writes will occur. The core 820A can send a register-write message for register R0 with the committed value of 4 to core 820B; the core 820B updates the previous register value 932 with the 4 for register R0; the register write message is not forwarded from the core 820B because the write mask for register R0 is asserted but the register R0 was not written by the core 820B. The core 820A can send a register-write message for register R2 with the committed value of 7 to core 820B; the core 820B updates the previous register value 932 with the 7 for register R2; the register write message is forwarded from the core 820B to the core 820C because the write mask for register R0 is not asserted in core 820B; the core 820C updates the previous register value 932 with the 7 for register R2. When all of the register write messages are sent from core 820A, the core 820A sends the abort message to the core 820B and the core 820A transitions to the idle state. When the core 820B receives the abort message, the core 820B enters the abort state. The core 820B can send a register-write message for register R5 with the committed value to core 820C; the core 820C updates the previous register value 932 with the committed value for register R5; the register write message is forwarded from the core 820C, and so forth. When all of the register write messages are sent from core 820B, the core 820B sends the abort message to the core 820C and the core 820B transitions to the idle state. When the core 820C receives the abort message, the core 820C enters the abort state. Since no registers were written by the core 820C, the core 820C can forward the abort message to the core 820D and the core 820C can transition to the idle state. When the core 820D receives the abort message, the core 820D can generate the completed abort signal and execution can be restarted with all of the register values in the transactional register file 830 being the committed values. In this manner, the atomic execution model can be supported while allowing early speculative values to be used to potentially increase parallel computation of a single thread.

In another embodiment of a distributed transacted register file, each transacted register file instance 830B can include per-entry fields 940 (including 942, 944, 946) as described above, and register values 930 including only previous value 932 (but not next value 934). Each transmitter 822-receiver 824 pair (e.g. 822D-824A) can include between or amongst them a first-in, first-out elastic buffer (FIFO) of messages such that inter-core messages between the cores can be temporarily buffered (queued) as may occur when a core 820 is in non-speculative execution state 1020, or may be immediately processed as usual as may occur when a core 820 is in a state other than non-speculative execution state 1020. In this alternative embodiment, the FIFO queue serves to hold-off register write updates so that they do not prematurely update the register file state of the non-speculative block. Once the non-speculatively block commits, its state transitions to idle 1010 and in this mode the register write messages queued in the FIFO are finally processed just as described above, but updating that core's register file's previous value(s) 932.

FIG. 10 illustrates an example state diagram 1000 for a block-based processor core. For example, the state diagram 1000 can represent the states and state transitions of the state machine 950 of FIG. 9. The state machine corresponding to the state diagram 1000 can be implemented at least in part using one or more of: hardwired finite state machines, programmable microcode, programmable gate arrays, or other suitable control circuits. The states of the state machine can be used to determine actions to perform when various operational conditions are detected by the processor core and/or when messages are received at the processor core. For example, a transactional register file can be updated based on a received message and a state of the state machine. It should be noted that each of the states in FIG. 10 can be in addition to or can potentially overlap with one or more of the states in FIG. 6. As a specific example, the idle state 1010 can include the unmapped (605), mapped (610), and idle (670) states from FIG. 6. As another specific example, the speculative execution state 1030 and the non-speculative execution state 1020 can include the fetch (620), decode (630), and execute (640) states from FIG. 6.

At idle state 1010, the processor core can be idle. During the idle state 1010, the processor core is not executing an instruction block and can be in a low-power state. Placing the processor core in the low-power state can include reducing the power of at least a portion of the logic of the processor core, such as by gating one or more clocks of the processor core, reducing a voltage or powering down one or more voltage islands of the processor core, and/or reducing a frequency of one or more clocks of the processor core. In one example, the messaging system and the transactional register file are not powered down when the processor core is in low-power mode so that the processor core can receive and transmit messages on the ring and so that states and values of the transactional register file can be updated when the processor core is idle. The idle processor core will generally not source messages to be transmitted on the communication ring, however, the idle processor core can receive messages from upstream processor cores and can forward messages to downstream processor cores. The idle processor core can update its transactional register file in response to receiving messages so that instruction blocks that may execute on the core in the future can access the latest committed or speculated register values.

Non-branch messages received by the idle processor core can affect state associated with the transactional register file of the idle processor core without causing the processor core to transition to a new state. For example, the pending register states can be updated in response to receiving a write-mask message. Since there is no write-mask associated with an idle processor core, the write-mask message can be forwarded to the downstream core without modification. As another example, the previous register values of the transactional register file can be updated in response to receiving a register-write message, and the pending register state can be deasserted for the register being written by the register-write message. The register-write message can be forwarded to the next downstream core. A pause message received by the idle core can be forwarded or dropped by the idle core. If the idle core was not in a low-power mode, the received pause message can cause the idle core to go into a low-power mode. An abort message received by the idle core can be forwarded or dropped by the idle core. As one example, the abort message can cause the pending register state to be flash-cleared or deasserted for the transactional register file.

A branch message received by the idle processor core can cause the processor core to transition to an execution state. In particular, if the idle core receives a branch message from an upstream processor core without a commit or oldest token (upstream branch 1012) the idle core can transition to the speculative execution state 1030. Alternatively, if the idle core receives a branch message from an upstream processor core with the commit token (upstream branch and commit token 1014) the idle core can transition to the non-speculative execution state 1020.

At the non-speculative execution state 1020, the processor core can execute instructions of a non-speculative instruction block. For example, the processor core can fetch the instruction block using an address provided in the branch message and the instruction block can be decoded and executed. The instruction block can include an instruction header having a write-mask that identifies all of the registers that can be written by the instruction block. The write mask can be stored in register state of the transaction register file of the non-speculative core. The non-speculative core can send a write-mask message with the information from the decoded write-mask to downstream cores so that the downstream cores receive an indication of which registers may be written by the non-speculative core. The instructions executing on the non-speculative core can write to the registers, and each register write can generate a register-write message to the downstream core. The non-speculative core can successfully complete and the visible architectural state can be committed. When the non-speculative core successfully completes (internal commit 1022), the processor core can transition to the idle state 1010. However, when the non-speculative core aborts (internal abort 1024), the processor core can transition to the abort state 1050. In this manner, the computation can be distributed over multiple processor cores as one instruction block executes and commits on one core and the next block executes and commit on another core. As a specific example from FIG. 8, the computation can proceed so that as the series of blocks commit, the oldest, non-speculating block may be found hosted on different cores over time, such as 820A, then 820B, then 820C, then 820D, then 820A again and so forth.

At the speculative execution state 1030, the processor core can speculatively execute instructions of a speculative instruction block. For example, the processor core can fetch the instruction block using an address provided in the branch message and the instruction block can be decoded and executed. The instruction block can include an instruction header having a write-mask that identifies all of the registers that can be written by the instruction block. The write mask can be stored in write-mask register state of the transaction register file of the non-speculative core. The speculative core can receive one or more write-mask messages indicating which registers may be written by upstream cores (such as the non-speculative core). The information from the write-mask messages can be used to determine instructions within the speculative core that are dependent on instructions from earlier blocks. The information from the write-mask messages can be stored in pending state of the transactional register file. The non-speculative core can send a composite write-mask message to the downstream core. The composite write-mask message can combine the pending state and the write-mask register state to provide an indication of which registers may be written by upstream cores. The instructions executing on the speculative core can write to the registers, and each register write can generate a register-write message to the downstream core. The speculative core can transition to the non-speculative state 1020 after the upstream core is non-speculative and successfully completes (upstream commit 1032). However, the instruction block executing on the speculative core can be aborted if an upstream core aborts, if the speculative core is mispeculated, or if the speculative self-aborts due to an exception. As one example, an upstream aborting core can send a pause message to the speculative core so that the speculative core can stop updating state that will be rolled back. In particular, the speculative core can receive a pause message (pause 1034) and can transition to a pause state 1040. As another example, the speculative core can receive an abort message (upstream abort 1036) and can transition to the abort state 1050.

At the pause state 1040, the processor core can be paused. As one example, the instruction scheduler can stop issuing instructions to be executed by the core. By stopping instructions from being issued, further speculative changes to the architectural state caused by the non-issued instructions can be prevented so that the architectural state can be rolled back to the committed state faster than if the core were not paused. Additionally, energy associated with executing the non-issued instructions can potentially be reduced or eliminated. The energy can be further reduced by placing the processor core in a low-power mode as described above. A core in the pause state 1040 can receive register-write messages from upstream cores as the register values of the transactional register file are returned to the committed values. The paused core can update the previous register value identified in the register-write message, and the register-write message can be forwarded to the downstream core unless the write-mask corresponding to the register-write message is asserted for the paused core. The processor core can transition to the abort state 1050 when the paused core receives an abort message (upstream abort 1042).

At the abort state 1050, the processor core can roll back any architectural state that was updated by the processor core. As one example, any registers that were speculatively written by the processor core can be returned to the committed state of the registers. The registers speculatively written by the processor core are identified by the written state of the transactional register file. When the processor core is in the abort state 1050, the previous register value of the transactional register file holds the committed value for each register. Thus, the processor core can update a speculatively written register in a downstream processor core by sending a register-write message with the committed value (as read from the previous register value) to the downstream core. The processor core can sequence through each of the registers that were speculatively written by the processor core, sending a register-write message for each of the speculatively written registers. The processor core can finish with the abort state 1050 when all of the speculatively written registers have been returned to their committed values and any other abort clean-up conditions are complete. When the abort clean-up conditions are complete (internal done), the processor core can transition to the idle state 1010.

X. Example Methods of using Transactional Register Files

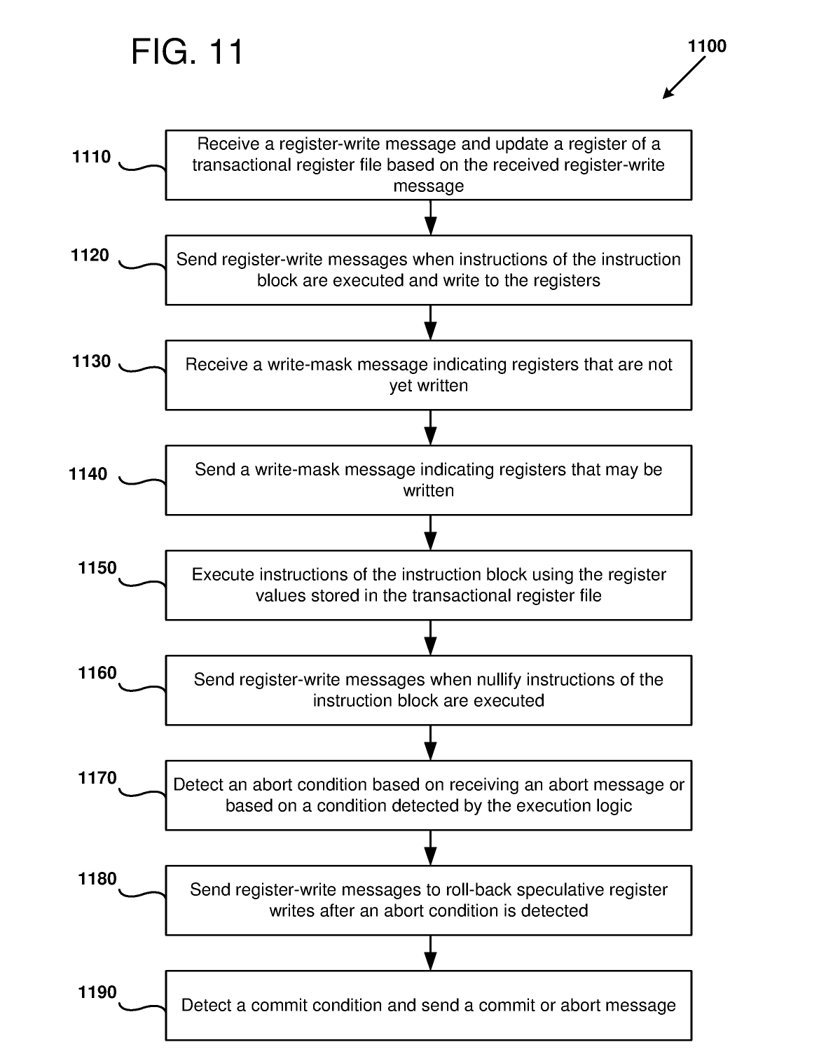

FIG. 11 is a flowchart illustrating an example method 1100 of executing an instruction block of a program on a processor core. For example, the method 1100 can be performed by the processor cores 820A-D of FIGS. 8-9. The processor cores can be connected in a ring so that each processor core can receive messages from an upstream processor core and can send messages to a downstream processor core. A processor core can include a transactional register file and an execution unit. The transactional register file can include a plurality of registers, where each register includes a previous value field and a next value field. The execution unit can be configured to execute instructions of the instruction block.

At process block 1110, a register-write message can be received at a processor core and a register of a transactional register file can be updated based on the received register-write message. The register-write message can include a processor core or instruction block identifier, a register identifier, and a register value. The processor core or instruction block identifier can identify the source of the register-write message. The register of the transactional register file can be updated in different ways based on the source of the register-write message and a state of the processor core. As one example, the processor core can be in a speculative execution state and the register-write message can be generated by a different processor core executing an instruction block earlier in program order than the instruction block speculatively executing on the processor core. In this case, the previous value field of the register entry in the transactional register file can be updated using the register value of the register-write message. Specifically, the register identified by the register-write message can be used to store a value corresponding to a state before execution of the instruction block on the processor core. As another example, the processor core can be in a non-speculative execution state. In this case, the next value field of the transactional register file can be updated using the register value of the register-write message. Specifically, the register identified by the register-write message can be used to store a value corresponding to a state after the instruction block is executed and committed by the processor core.

At process block 1120, register-write messages can be sent when instructions of the instruction block are executed and the instructions write to the registers. The execution logic can generate a result when an instruction is executed. As one example, the result of the instruction is not used by other instructions of the instruction block, but rather the execution logic can cause the result to be sent to downstream processor cores using a register-write message. Specifically, the register-write message can include the source processor core or instruction block identifier, the targeted register identifier, and the generated result.

At process block 1130, a write-mask message can be received that indicates registers that are not yet written by earlier instruction blocks. As one example, the write-mask message can include a bit vector, where each bit of the vector corresponds to one of the registers of the transactional register file. A bit of the bit vector can be asserted (e.g., set to 1) when the corresponding register will be written by an earlier instruction block, but the register has not been written yet; a bit of the bit vector can be deasserted (e.g., set to 0) when the corresponding register will not be written by an earlier instruction block. The information from the received write-mask message can be stored as a pending status for each register. Specifically, the pending status for each register can be asserted when the corresponding bit is asserted in a received write-mask message. The pending status for each register can be deasserted when a register-write message corresponding to the register is received.

At process block 1140, a write-mask message indicating registers that may be written by the instruction block can be sent. For example, each instruction block can include an instruction header having a write-mask that identifies all of the registers that may be written by the instruction block. The write-mask can include the registers that are written by predicated and/or non-predicated instructions. The write-mask message can be sent after the write mask of the instruction header is decoded, for example.

At process block 1150, the instructions of the instruction block can be executed using the register values stored in the local core's transactional register file. The instructions can be issued in a dataflow order as the operands of the instructions become available. For example, some of the instructions can use register values generated by different instruction blocks (e.g., instruction blocks earlier in program order) and stored in the transactional register file. The pending status for each register can be used to determine if the register value has yet been written to the register and therefore if the instruction is ready to issue. Specifically, the execution of an instruction reading a register can be delayed until after the pending status for the register is deasserted. After the pending status is deasserted, the previous value field of the register can be used by the execution logic for executing the instruction.

At process block 1160, register-write messages can be sent when nullify instructions of the instruction block are executed. As described above, the write mask can include the registers that are written by predicated and/or non-predicated instructions. Predicated instructions may or may not execute depending on a calculated predicate value. In one example, the predicate values can be true or false. If a given register is written only for a predicate value that does not occur (e.g., a true value), a nullify instruction can be used to release the pending state of the register for the predicate value that does occur (e.g., a false value). The register-write message sent in response to executing a nullify instruction can include the source processor core or instruction block identifier, the targeted register identifier, and the value from the previous value field.

At process block 1170, an abort condition can be detected based on receiving an abort message or based on a condition detected by the execution logic. When an abort condition is detected, any speculative state can be rolled back so that only the committed state before the abort condition is present before restarting execution. The abort condition can be detected by an upstream processor core which can send an abort message or the abort condition can be detected by the execution logic, such as when an exception occurs (such as a divide by zero), for example. When the abort condition is detected, the processor core can transition to the abort state. As one example, a pause message can be transmitted in response to entering the abort state. Receiving a pause message can cause the processor core to stop issuing instructions so that speculative execution will stop. Receiving a pause message can cause the processor core enter a low-power mode where a portion of the processor core is clock gated or powered down to reduce power consumption while other processor cores are rolling back speculative state.

At process block 1180, register-write messages can be sent to roll-back or undo speculative register writes after the abort condition is detected. For example, the processor core can determine all of the all registers of the transactional register file speculatively written by the instructions of the instruction block. The processor core can cause a register-write message to be transmitted for each register speculatively written by the instructions of the instruction block. The register-write message can include the source processor core or instruction block identifier, the targeted register identifier, and the value from the previous value field of the targeted register. The processor core can cause an abort message to be transmitted after the abort condition is detected and after all of the register-write messages for each register speculatively written by the instructions of the instruction block are transmitted from the processor core.

At process block 1190, a commit condition can be detected and a commit or abort message can be sent from the processor core. As one example, the commit conditions can include all register writes of the instruction block being complete, all stores to the memory being complete, and a branch address being calculated. When a commit condition is detected, the processor core can swap the previous value field and the next value field of the registers of the transactional register file. The processor core can also compare the calculated branch address to an earlier predicted branch address. For example, a branch predictor of the processor core can predict a branch address and cause a branch message to be sent to the downstream core causing the downstream core to begin speculatively executing an instruction block at the predicted branch address. If predicted branch address was mispredicted, the processor core can transmit an abort message to the downstream core. If predicted branch address was predicted correctly, the processor core can transmit a commit message to the downstream core.

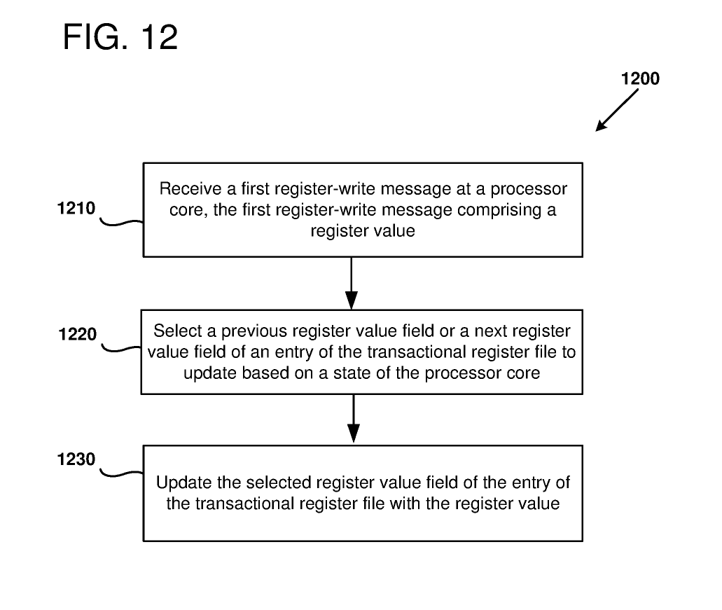

FIG. 12 is a flowchart illustrating an example method 1200 of executing an instruction block of a program on a processor core. For example, the method 1200 can be performed by one or more of the processor cores 820A-D of FIGS. 8-9.

At process block 1210, a register-write message can be received at a processor core. The register-write message can include a register value.

At process block 1220, a previous register value field or a next register value field of an entry of the transactional register file can be selected to update based on a state of the processor core. For example, the processor core states can include idle, speculative execution, non-speculative execution, abort, and pause.

At process block 1230, the selected field of the entry of the transactional register file can be updated with the register value. As one example, the next register value field can be updated with the register value when the state of the processor core is non-speculative. As another example, the previous register value field can be updated with the register value when the state of the processor core is not non-speculative.

### XI. Example Computing Environment

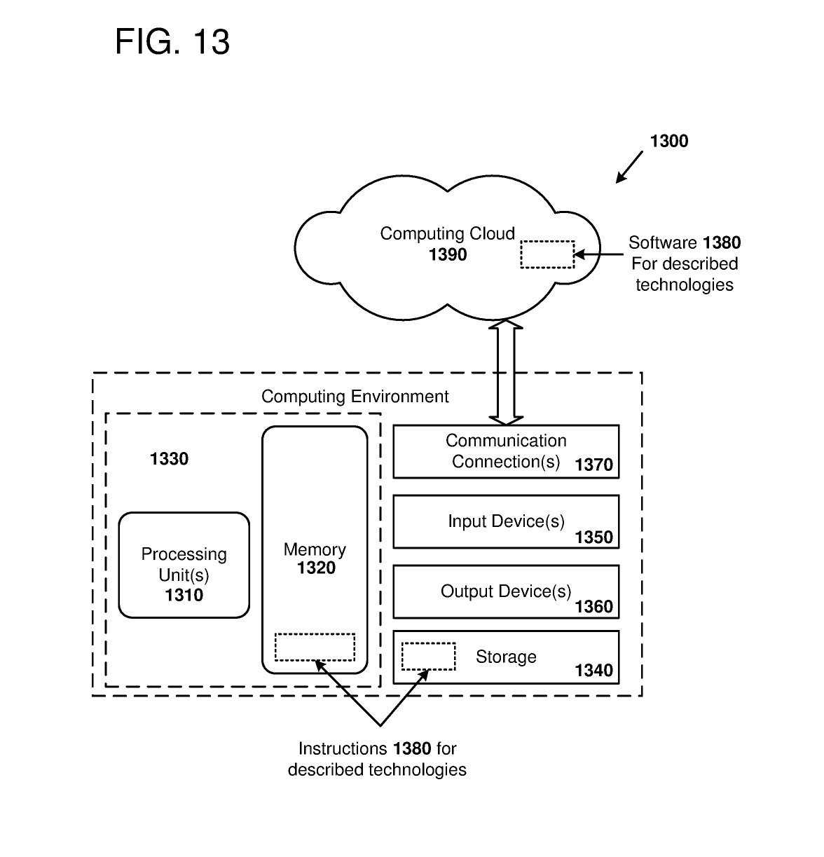

FIG. 13 illustrates a generalized example of a suitable computing environment 1300 in which the described embodiments, techniques, and technologies can be implemented.

The computing environment 1300 is not intended to suggest any limitation as to scope of use or functionality of the technology, as the technology may be implemented in diverse general-purpose or special-purpose computing environments. For example, the disclosed technology may be implemented with other computer system configurations, including hand held devices, multi-processor systems, programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules (including executable instructions for block-based instruction blocks) may be located in both local and remote memory storage devices.

With reference to FIG. 13, the computing environment 1300 includes at least one block-based processing unit 1310 and memory 1320. In FIG. 13, this most basic configuration 1330 is included within a dashed line. The block-based processing unit 1310 executes computer-executable instructions and may be a real or a virtual processor. In a multi-processing system, multiple processing units execute computer-executable instructions to increase processing power and as such, multiple processors can be running simultaneously. The memory 1320 may be volatile memory (e.g., registers, cache, RAM), non-volatile memory (e.g., ROM, EEPROM, flash memory, etc.), or some combination of the two. The memory 1320 stores software 1380, images, and video that can, for example, implement the technologies described herein. A computing environment may have additional features. For example, the computing environment 1300 includes storage 1340, one or more input devices 1350, one or more output devices 1360, and one or more communication connections 1370. An interconnection mechanism (not shown) such as a bus, a controller, or a network, interconnects the components of the computing environment 1300. Typically, operating system software (not shown) provides an operating environment for other software executing in the computing environment 1300, and coordinates activities of the components of the computing environment 1300.

The storage 1340 may be removable or non-removable, and includes magnetic disks, magnetic tapes or cassettes, CD-ROMs, CD-RWs, DVDs, or any other medium which can be used to store information and that can be accessed within the computing environment 1300. The storage 1340 stores instructions for the software 1380, plugin data, and messages, which can be used to implement technologies described herein.

The input device(s) 1350 may be a touch input device, such as a keyboard, keypad, mouse, touch screen display, pen, or trackball, a voice input device, a scanning device, or another device, that provides input to the computing environment 1300. For audio, the input device(s) 1350 may be a sound card or similar device that accepts audio input in analog or digital form, or a CD-ROM reader that provides audio samples to the computing environment 1300. The output device(s) 1360 may be a display, printer, speaker, CD-writer, or another device that provides output from the computing environment 1300.

The communication connection(s) 1370 enable communication over a communication medium (e.g., a connecting network) to another computing entity. The communication medium conveys information such as computer-executable instructions, compressed graphics information, video, or other data in a modulated data signal. The communication connection(s) 1370 are not limited to wired connections (e.g., megabit or gigabit Ethernet, Infiniband, Fibre Channel over electrical or fiber optic connections) but also include wireless technologies (e.g., RF connections via Bluetooth, WiFi (IEEE 802.11a/b/n), WiMax, cellular, satellite, laser, infrared) and other suitable communication connections for providing a network connection for the disclosed agents, bridges, and agent data consumers. In a virtual host environment, the communication(s) connections can be a virtualized network connection provided by the virtual host.

Some embodiments of the disclosed methods can be performed using computer-executable instructions implementing all or a portion of the disclosed technology in a computing cloud 1390. For example, disclosed compilers and/or block-based-processor servers are located in the computing environment 1330, or the disclosed compilers can be executed on servers located in the computing cloud 1390. In some examples, the disclosed compilers execute on traditional central processing units (e.g., RISC or CISC processors).

Computer-readable media are any available media that can be accessed within a computing environment 1300. By way of example, and not limitation, with the computing environment 1300, computer-readable media include memory 1320 and/or storage 1340. As should be readily understood, the term computer-readable storage media includes the media for data storage such as memory 1320 and storage 1340, and not transmission media such as modulated data signals.

### XII. Additional Examples of the Disclosed Technology

Additional examples of the disclosed subject matter are discussed herein in accordance with the examples discussed above.

In one embodiment, a processor can include a plurality of block-based processor cores. A block-based processor core can be used for executing an instruction block. The processor core includes a transactional register file and an execution unit. The transactional register file includes a plurality of registers, each register including a previous value field and a next value field. The previous value field can be used for storing a value corresponding to a state before execution of the instruction block on the processor core. The next value field can be used for storing a value corresponding to a state after execution of the instruction block on the processor core. The next value field is updated when a register-write message is received and the processor core is executing non-speculatively. The previous value field is updated when a register-write message is received and the processor core is executing speculatively. The execution unit is configured to execute instructions of the instruction block. The execution unit is further configured to read register values from the previous value field of the transactional register file and to cause register-write messages to be transmitted from the processor core when the instructions of the instruction block write to the registers. The execution unit can be further configured to cause a register-write message to be transmitted from the processor core in response to a nullify instruction being executed, the nullify instruction indicating a register that is not written by the instruction block. The register-write message can include the value stored in the previous value field for the register that is not written by the instruction block.

The transactional register file can further include a pending state for each register of the plurality of registers. The pending state can be asserted in response to receiving a write-mask message indicating the register is written by an instruction of an instruction block earlier in program order than the instruction block executed on the processor core. The processor core can further include instruction scheduler logic configured to issue the instructions of the instruction block to the execution logic in a dataflow order based at least in part on the pending state for each register of the transactional register file. The processor core can further include decode logic configured to determine registers to be written by the instructions of the instruction block and to cause a write-mask message to be transmitted from the processor core. The write-mask message can indicate at least the registers to be written by the instructions of the instruction block. For example, the write-mask message can indicate the registers to be written by the instructions of the instruction block and registers having an asserted pending state.

The execution logic can be further configured to detect an abort condition of an instruction of the instruction block and to cause a pause message to be transmitted from the processor core when the abort condition is detected. The processor core can further include abort management logic configured to determine all registers of the transactional register file speculatively written by the instructions of the instruction block and to perform a rollback action that restores a value of each register speculatively written by the instructions of the instruction block. For example, the rollback action can be to cause a register-write message to be transmitted from the processor core for each register speculatively written by the instructions of the instruction block. The register-write message can include the value stored in the previous value field for each register. The abort management logic can be further configured to cause an abort message to be transmitted from the processor core after the abort condition is detected and after all of the register-write messages for each register speculatively written by the instructions of the instruction block are transmitted from the processor core.

In an alternative embodiment, each processor core can include n instruction windows and each instruction window can include a transactional register file. The transactional register files of the different instruction windows can be connected similarly to connections between the different processor cores. In yet another alternative embodiment, a processor can include a single processor core and the message transmitter can be connected to the message receiver. Any of the processors can be implemented using programmable or configurable logic (such as within an FPGA).

One or more of the processors can be used in a variety of different computing systems. For example, a server computer can include non-volatile memory and/or storage devices; a network connection; memory storing one or more instruction blocks; and the processor including the block-based processor core for executing the instruction blocks. As another example, a device can include a user-interface component; non-volatile memory and/or storage devices; a cellular and/or network connection; memory storing one or more of the instruction blocks; and the processor including the block-based processor core for executing the instruction blocks. The user-interface component can include at least one or more of the following: a display, a touchscreen display, a haptic input/output device, a motion sensing input device, and/or a voice input device.

In one embodiment, a method of executing an instruction block includes receiving a first register-write message at a processor core, the first register-write message comprising a register value. The method further includes selecting a previous register value field or a next register value field of an entry of the transactional register file to update based on a state of the processor core. The method further includes updating the selected field of the entry of the transactional register file with the register value. The next register value field can be selected for updating when the state of the processor core is a non-speculative execution state. The previous register value field can be selected for updating when the state of the processor core is not a non-speculative execution state.

The method can further include determining registers of the transactional register file to be written by the instruction block and transmitting a write-mask message from the processor core, the write-mask message indicating the registers of the transactional register file to be written by the instruction block. The method can further include receiving a write-mask message at the processor core, the write-mask message indicating the registers of the transactional register file to be written by one or more instruction blocks earlier in program order than the instruction block. The method can further include issuing the instructions of the instruction block for execution in a dataflow order based at least in part on the received write-mask message.

The method can further include determining registers of the transactional register file to be written by one or more instruction blocks earlier in program order than the instruction block. The method can further include determining registers of the transactional register file to be written by the instruction block. The method can further include transmitting a write-mask message from the processor core. The write-mask message can indicate the registers of the transactional register file to be written by the instruction block and by the one or more instruction blocks earlier in program order than the instruction block.

The method can further include executing an instruction of the instruction block to generate a result of the instruction, and transmitting a second register-write message from the processor core in response to executing the instruction when the instruction specifies a register of the transactional register file to write. The second register-write message can include a register identifier of the register and the result of the instruction. The method can further include causing a third register-write message to be transmitted from the processor core during an abort state of the processor core. The third register-write message including the register identifier of the register and the value stored in the previous value field of the register.

The method can further include executing a nullify instruction of the instruction block, where the nullify instruction specifies that a register of the transactional register file is not written by the instruction block. The method can further include transmitting a second register-write message from the processor core in response to executing the nullify instruction. The second register-write message can include the value stored in the previous register value field for the nullified register.

One or more computer-readable storage media can store computer-readable instructions that, when executed by a computer, cause the computer to perform the method.

In one embodiment, a block-based processor core can be used for executing instructions of an instruction block. The processor core includes a communication system, a transactional register file, and execution logic. The communication system is configured to receive and transmit messages. For example, the communication system can be configured to receive messages from an upstream processor core and to transmit messages to a downstream processor core. The transactional register file includes a plurality of registers, where each register includes a previous value field and a next value field. The previous value field is configured to be updated based on the communication system receiving a register-write message when the processor core is in a first operational state. The next value field is configured to be updated based on the communication system receiving a register-write message when the state machine is in a second operational state different from the first operational state. For example, the operational state of the processor core can be maintained by a state machine. In particular, the state machine can be configured to track an operational state of the processor core based on the messages received by the communication system and results of executing the instructions of the instruction block. The execution logic is configured to execute the instructions of the instruction block. The execution logic is further configured to read register values from the previous value field of the transactional register file and to cause register-write messages to be transmitted by the communication system when the instructions of the instruction block write to the registers.

The processor can further include abort management logic configured to detect an abort condition based on the communication system receiving an abort message and cause register-write messages to be transmitted by the communication system for each register speculatively written by the executed instructions of the instruction block.

In view of the many possible embodiments to which the principles of the disclosed subject matter may be applied, it should be recognized that the illustrated embodiments are only preferred examples and should not be taken as limiting the scope of the claims to those preferred examples. Rather, the scope of the claimed subject matter is defined by the following claims. We therefore claim as our invention all that comes within the scope of these claims.

We claim:

1. A block-based processor core for executing an instruction block, the processor core comprising:
a transactional register file comprising a plurality of registers, each register including a previous value field and a next value field, the previous value field for storing a value corresponding to a state before execution of the instruction block on the processor core, the next value field for storing a value corresponding to a state after execution of the instruction block on the processor core, the next value field being updated when a register-write message is received and the processor core is executing non-speculatively, and the previous value field being updated when a register-write message is received and the processor core is executing speculatively; and
an execution unit configured to execute instructions of the instruction block, the execution unit configured to read register values from the previous value field of the transactional register file and to cause register-write messages to be transmitted from the processor core when the instructions of the instruction block write to the registers.

2. The processor core of claim 1, wherein the transactional register file further comprises a pending state for each register of the plurality of registers, and the pending state is asserted in response to receiving a write-mask message indicating the register is written by an instruction of an instruction block earlier in program order than the instruction block being executed on the processor core.

3. The processor core of claim 2, further comprising:
instruction scheduler logic configured to issue the instructions of the instruction block to the execution unit in a dataflow order based at least in part on the pending state for each register of the transactional register file.

4. The processor core of claim 2, further comprising:
decode logic configured to determine registers to be written by the instructions of the instruction block and to cause a write-mask message to be transmitted from the processor core, the write-mask message indicating at least the registers to be written by the instructions of the instruction block.

5. The processor core of claim 4, wherein the write-mask message indicates the registers to be written by the instructions of the instruction block and registers having an asserted pending state.

6. The processor core of claim 1, wherein the execution unit is further configured to detect an abort condition of an instruction of the instruction block and to cause a pause message to be transmitted from the processor core when the abort condition is detected.

7. The processor core of claim 6, further comprising:
abort management logic configured to determine all registers of the transactional register file speculatively written by the instructions of the instruction block and to perform a rollback action that restores a value of each register speculatively written by the instructions of the instruction block.

8. The processor core of claim 7, wherein the abort management logic is further configured to cause an abort message to be transmitted from the processor core after the abort condition is detected and after all of the register-write messages for each register speculatively written by the instructions of the instruction block are transmitted from the processor core.

9. The processor core of claim 1, wherein the execution unit is further configured to cause a register-write message to be transmitted from the processor core in response to a nullify instruction being executed, the nullify instruction indicating a register that is not written by the instruction block, the register-write message including the value stored in the previous value field for the register that is not written by the instruction block.

10. A method of executing an instruction block, the method comprising:
receiving a first register-write message at a processor core, the first register-write message comprising a register value;
selecting a previous register value field or a next register value field of an entry of a transactional register file to update based on a state of the processor core; and
updating the selected register value field of the entry of the transactional register file with the register value.

11. The method of claim 10, wherein the next register value field is selected for updating when the state of the processor core is a non-speculative execution state.

12. The method of claim 10, wherein the previous register value field is selected for updating when the state of the processor core is not a non-speculative execution state.

13. The method of claim 10, further comprising:
receiving a write-mask message at the processor core, the write-mask message indicating the registers of the transactional register file to be written by one or more instruction blocks earlier in program order than the instruction block; and
issuing the instructions of the instruction block for execution in a dataflow order based at least in part on the received write-mask message.

14. The method of claim 10, further comprising:
executing an instruction of the instruction block to generate a result of the instruction; and
transmitting a second register-write message from the processor core in response to executing the instruction when the instruction specifies a register of the transactional register file to write, the second register-write message including a register identifier of the register and the result of the instruction.

15. The method of claim 14, further comprising:
causing a third register-write message to be transmitted from the processor core during an abort state of the processor core, the third register-write message including the register identifier of the register and the value stored in the previous value field of the register.

16. The method of claim 10, further comprising:
executing a nullify instruction of the instruction block, the nullify instruction specifying that a register of the transactional register file is not written by the instruction block, thereby specifying the register is a nullified register; and
transmitting a second register-write message from the processor core in response to executing the nullify instruction, the second register-write message including the value stored in the previous register value field for the nullified register.

17. A block-based processor core for executing instructions of an instruction block, the processor core comprising:
a communication system configured to receive and transmit messages;
a transactional register file comprising a plurality of registers, each register including a previous value field and a next value field, the previous value field being configured to be updated based on the communication system receiving a register-write message when the processor core is in a first operational state, and the next value field being configured to be updated based on the communication system receiving a register-write message when the processor core is in a second operational state different from the first operational state; and
execution logic configured to execute the instructions of the instruction block, the execution logic being configured to read register values from the previous value field of the transactional register file and to cause register-write messages to be transmitted by the communication system when the instructions of the instruction block write to the registers.

18. The processor core of claim 17, wherein the communication system configured to receive messages from an upstream processor core and to transmit messages to a downstream processor core.

19. The processor core of claim 17, wherein the operational state of the processor core is maintained by a state machine configured to track the operational state of the processor core based on the messages received by the communication system and results of executing the instructions of the instruction block.

20. The processor core of claim 17, further comprising:
abort management logic configured to:
detect an abort condition based on the communication system receiving an abort message; and
cause register-write messages to be transmitted by the communication system for each register speculatively written by the executed instructions of the instruction block.
